(19) United States
(12) Patent Application Publication
(10) Pub. No.: US 2026/0240121 A1
(43) Pub. Date: Aug. 20, 2026

(54) ANIMAL COLLAR SYSTEM WITH ACTIVITY CLASSIFICATION AND RELATED METHODS

(71) Applicant: Smart Tracking Technologies, LLC, Jacksonville, FL (US)

(72) Inventors: Donny C. Lamey, Jr., Jacksonville, FL (US); Brent Duncan, Richardson, TX (US); Colby Ryan, Richardson, TX (US); Joseph T. McKee, Stamford, CT (US); Paulina Mosley, Richardson, TX (US); Eugene Van Beljon, Grapevine, TX (US); William Walter Jerla Jr., Jacksonville, FL (US)

(21) Appl. No.: 19/168,862

(22) PCT Filed: Mar. 29, 2024
(86) PCT No.: PCT/US2024/022202

§ 371 Date: Sep. 25, 2025

Related U.S. Application Data
(60) Provisional application No. 63/492,835, filed on Mar. 29, 2023.

(51) Int. Cl. A01K 29/00; A01K 27/00

(52) U.S. Cl. CPC A01K 29/007; A01K 27/009

(57) ABSTRACT

An animal collar system (300) is for monitoring an animal, and includes a mobile device (302) associated with a user, and a server (360) coupled communicating with the mobile device over a network (304). The animal collar system also includes an animal collar device (305) associated with the animal and having a circuit board, and a local wireless transceiver (310) carried by the circuit board and configured to communicate with the mobile device. The animal collar device has sensing components (307) carried by the circuit board and configured to collect data about the animal, and a processor (312) carried by the circuit board and coupled to the local wireless transceiver and the sensing components. The processor is configured to transmit the data about the animal to the mobile device (302), and the mobile device is configured to transmit the data about the animal to the server over the network. The server is configured to classify an activity of the animal based upon the data about the animal and an ML model.

### RELATED APPLICATION

This application is based upon prior filed copending Application No. 63/492,835 filed Mar. 29, 2023, the entire subject matter of which is incorporated herein by reference in its entirety.

### TECHNICAL FIELD

The present disclosure relates to the field of wearable tracker devices, and, more particularly, to an animal wearable tracker device and related methods.

### BACKGROUND

A number of wearable electronics have been designed for humans. Many of these “wearables” are focused on health and wellness. These fitness wearables are typically in the form of a bracelet and are designed to collect information from the user. These fitness wearables monitor the activity and heart rate of the user using a gyroscope and/or heart rate sensor and transmit that data to the user.

Other wearables are focused on connectivity. These wearables are typically in the form of a “smartwatch” and are designed to present information from the user's smartphone to the user. These smartwatches receive notifications from the user's smartphone via Bluetooth or from a server via Wi-Fi, alert the user with a sound or vibration and then present that notification visually on a screen.

Still other wearables provide a measure of interactivity. For example, many of the more feature-packed smartwatches allow the user to answer phone calls using a built-in microphone and speaker. In another example, many of the more feature-packed smartwatches allow the user to input information using their voice, hand gestures, a stylus or mechanical components on the watch. Many of these feature-packed smartwatches also incorporate the fitness components provided by fitness wearables.

### SUMMARY

Generally, an animal collar system is for monitoring an animal, and comprises a mobile device associated with a user, and a server coupled communicating with the mobile device over a network. The animal collar system also includes an animal collar device associated with the animal and comprising a circuit board, and a local wireless transceiver carried by the circuit board and configured to communicate with the mobile device. The animal collar device comprises a plurality of sensing components carried by the circuit board and configured to collect data about the animal, and a processor carried by the circuit board and coupled to the local wireless transceiver and the plurality of sensing components, the processor configured to transmit the data about the animal to the mobile device, the mobile device configured transmit the data about the animal to the server over the network. The server is configured to classify at least one activity of the animal based upon the data about the animal and a machine learning (ML) model.

More specifically, the server may be configured to perform a pre-process operation on the data about the animal, the pre-process operation comprising processing the data about the animal in a plurality of windows for the data about the animal. The pre-process operation may include generating a plurality of variables for each of the plurality of windows. For example, the plurality of variables may comprise a mean value, a number of zero crosses, a statistical variance, an energy value, a peak-to-peak value, a minimum value, and a maximum value. The server may be configured to ingest the plurality of variables for each of the plurality of the windows into the ML model.

The server may be configured to operate the ML model to classify the at least one activity of the animal for each of the plurality of windows. The pre-process operation may comprise classifying the data about the animal based upon at least one of an animal type, an animal breed, and an animal age.

In some embodiments, the mobile device may be configured to generate video data of the animal, the video data of the animal being concurrent with the data about the animal. The server may be configured to plot the data about the animal on a waveform, and segment the waveform based upon the video data of the animal.

Also, the plurality of sensing components may comprise an inertial measurement unit (IMU) configured to generate motion data. The server may be configured to filter the motion data. The at least one activity of the animal may comprise a plurality thereof, the plurality of activities comprising barking, sleeping, walking, and running.

Another aspect is directed to a method for monitoring an animal with an animal collar system comprising a mobile device associated with a user, a server coupled communicating with the mobile device over a network, and an animal collar device associated with the animal. The method comprises operating a local wireless transceiver in the animal collar device to communicate with the mobile device, and operating a plurality of sensing components in the animal collar device to collect data about the animal. The method also includes operating a processor in the animal collar device to transmit the data about the animal to the mobile device, the mobile device configured transmit the data about the animal to the server over the network, and operating the server to classify at least one activity of the animal based upon the data about the animal and a ML model.

### BRIEF DESCRIPTION OF THE DRAWINGS

FIG. 1 is a schematic diagram of a first embodiment of an animal collar system, according to the present disclosure.

FIGS. 2A and 2B are schematic perspective views of the first and second housing sections from the animal collar device in the animal collar system of FIG. 1.

FIG. 2C is a schematic perspective view of a first example embodiment of the collar assembly from the animal collar device in the animal collar system of FIG. 1.

FIG. 3 is a schematic perspective view of the first and second housing sections with the tracker device from the animal collar device in the animal collar system of FIG. 1.

FIG. 4 is a schematic perspective view of the second housing section from the animal collar device in the animal collar system of FIG. 1.

FIG. 5 is a schematic exploded view of the tracker device from the animal collar device in the animal collar system of FIG. 1.

FIG. 6 is a schematic exploded view of the tracker device and the first housing section from the animal collar device in the animal collar system of FIG. 1.

FIG. 7 is a schematic top plan view of the tracker device and the first housing section from the animal collar device in the animal collar system of FIG. 1.

FIG. 8 is a schematic cross-sectional view of the tracker device and the first housing section from the animal collar device in the animal collar system of FIG. 1 along line 8-8.

FIG. 9 is a schematic top plan view of the tracker device and the second housing section from the animal collar device in the animal collar system of FIG. 1.

FIG. 10A is a schematic exploded view of the tracker device from the animal collar device in the animal collar system of FIG. 1.

FIGS. 10B and 10C are schematic perspective views of the antenna mount from the animal collar device in the animal collar system of FIG. 1.

FIG. 10D is a schematic perspective view of the first coil antenna from the animal collar device in the animal collar system of FIG. 1.

FIG. 10E is a schematic bottom plan view of the first coil antenna from the animal collar device in the animal collar system of FIG. 1.

FIGS. 11A and 11B are a schematic top plan view and an enlarged schematic top plan view, respectively, of the antenna mount from the animal collar device in the animal collar system of FIG. 1.

FIG. 12 is a schematic top plan view of the second patch antenna from the animal collar device in the animal collar system of FIG. 1.

FIG. 13A is a schematic perspective view of the battery from the animal collar device in the animal collar system of FIG. 1.

FIG. 13B is a schematic top plan view of the connector from the animal collar device in the animal collar system of FIG. 1.

FIG. 14 is a schematic perspective view of the charging connector from the animal collar device in the animal collar system of FIG. 1.

FIGS. 15A, 15B, and 15C are schematic perspective views of the base from the animal collar device in the animal collar system of FIG. 1.

FIG. 16 is a schematic exploded view of the collar assembly in the animal collar system of FIG. 1.

FIGS. 17A and 17B are schematic perspective views of the base from a second example embodiment of the collar assembly from the animal collar device in the animal collar system of FIG. 1.

FIG. 17C is a schematic perspective view of the charging port cover from the second example embodiment of the collar assembly.

FIGS. 18A and 18B are a schematic back plan view and a schematic cross-sectional view along line 18B-18B, respectively, of the second example embodiment of the collar assembly from the animal collar device in the animal collar system of FIG. 1.

FIG. 19 is a more detailed schematic diagram of the animal collar device in the animal collar system of FIG. 1.

FIGS. 20A-20E are screenshots of an example embodiment of a user interface for the mobile device in the animal collar system of FIG. 1.

FIG. 21 is a schematic diagram of a second embodiment of the animal collar system, according to the present disclosure.

FIG. 22 is a confusion matrix for the ML model in the animal collar system of FIG. 21.

FIG. 23 is a receiver operating characteristic curve for the ML model in the animal collar system of FIG. 21.

FIG. 24 is a parallel coordinates plot for the ML model in the animal collar system of FIG. 21.

FIGS. 25-30 are screenshots from software implementing the ML model in the animal collar system of FIG. 21.

FIGS. 31A-31B are screenshots from software on the mobile device for generating training data for the ML model in the animal collar system of FIG. 21 FIG. 32 is flowchart showing operation of the ML model in the animal collar system of FIG. 21.

FIGS. 33-37 are screenshots from software on the mobile device for interacting with the generative artificial intelligence in the animal collar system of FIG. 21.

FIGS. 38-39 are schematic diagrams of architecture and flow in the generative artificial intelligence in the animal collar system of FIG. 21.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout, and base 100 reference numerals are used to indicate similar elements in alternative embodiments.

Another aspect is directed to a method for monitoring an animal. The method comprises transmitting data about the animal to a mobile device, the mobile device configured to transmit the data about the animal to a server over a network. The server is configured to classify at least one activity of the animal based upon the data about the animal and an ML model.

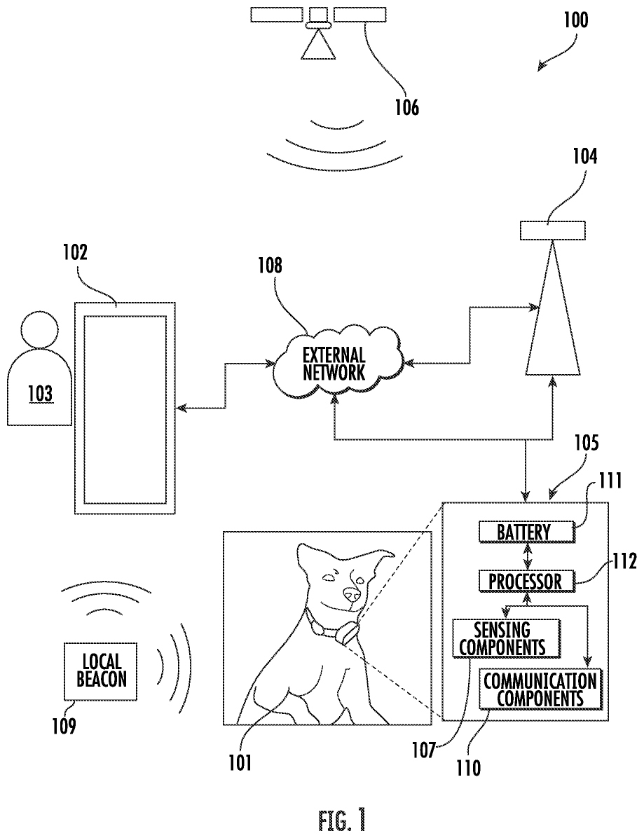

Referring initially to FIG. 1, an animal collar system 100, according to the present disclosure, for monitoring an animal 101 is now described. The animal collar system 100 illustratively includes a mobile device 102 (e.g., a smart phone device, a tablet computing device, a desktop computing device) associated with a user 103, a base station 104, and an animal collar device 105 in communication with the mobile device and the base station. The animal collar device 105 may also be in communication with a satellite 106 to provide a geolocation value. For example, the satellite 106 may be part of a global positioning system (GPS).

The animal collar device 105 illustratively comprises a plurality of monitoring/sensing components 107 configured to collect data about the animal 101. For example, the plurality of sensing components 107 may comprise one or more of a heart rate sensor, a body temperature sensor, and a gyroscope sensor (inertial measurement unit (IMU)). The animal collar device 105 illustratively comprises a plurality of communication components 110 configured to communicate the data about the animal 101 to the base station 104 and the mobile device 102. The plurality of communication components 110 may comprise one or more of an antenna, a wireless transceiver, and a wireless encoder/decoder circuit.

The animal collar device 105 illustratively comprises a battery 111 coupled to the plurality of sensing components 107 and the plurality of communication components 110. The animal collar device 105 illustratively comprises a processor 112 coupled to the battery 111. The processor 112 may comprise an integrated circuit (IC) processor, an application specific integrated circuit (ASIC), or a low power general purpose computing platform (e.g., Arduino).

The processor 112 is configured to determine whether the plurality of communication components 110 is connected to one or more of the base station 104 and the mobile device 102 to provide a location of the animal 101 relative to the base station and the mobile device. The processor 112 is also configured to cause the plurality of communication components 110 to transmit the data about the animal 101 via an external network 108 (e.g., the Internet).

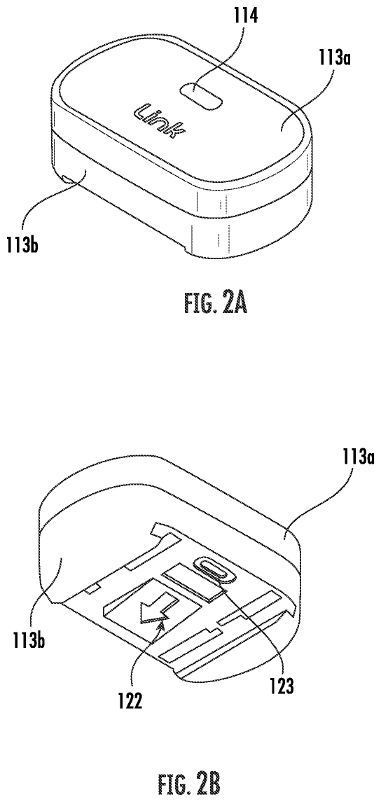

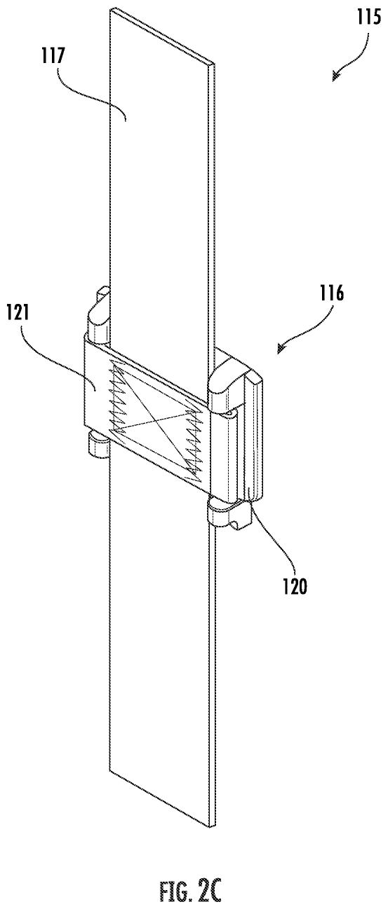

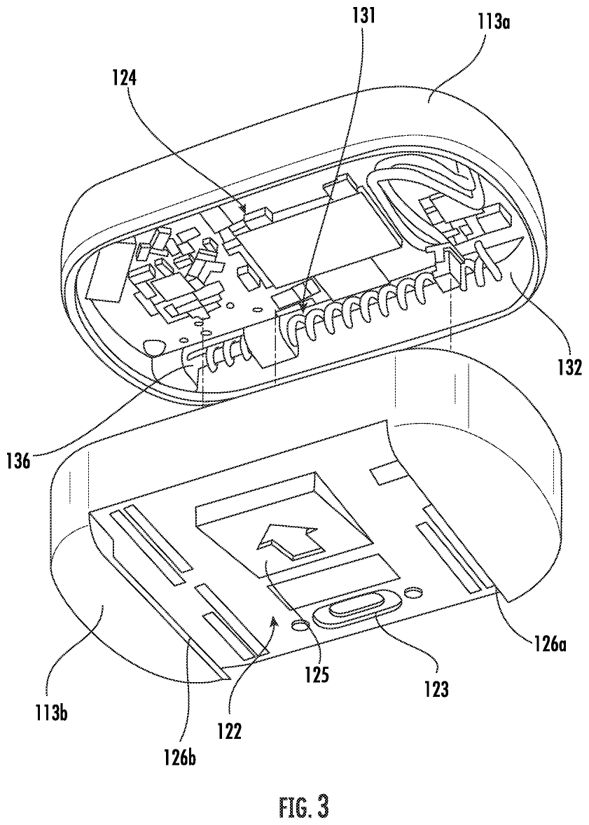

Referring now additionally to FIGS. 2A-2C, the animal collar device 105 illustratively includes a first housing section 113a, and a second housing section 113b coupled to the first housing section 113a. The first and second housing sections 113a-113b may comprise a dielectric material, for example, a polymer plastic material. The coupling may be accomplished by an ultrasonic welding, an adhesive material, or a mechanical interface lock, for example. The first housing section 113a comprises a visual indicator opening 114. The animal collar device 105 illustratively comprises a collar assembly 115 coupled to the second housing section 113b.

The collar assembly 115 comprises a retainer device 116, and a strap 117 extending through the retainer device and to wrap around the animal 101. The retainer device 116 comprises a base 120 coupling to the second housing section 113b and a retention arm 121 defining a slot to receive and retain the strap 117. The second housing section 113b illustratively includes an interface 122 for coupling to the base 120, and a charging port opening 123. The interface 122 comprises a ramp 125, and first and second opposing slots 126a-126b receiving the retainer device 116.

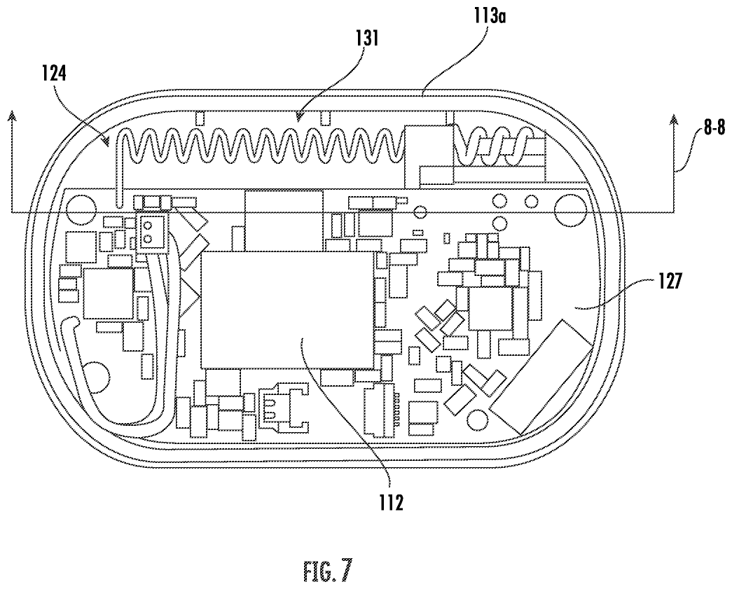

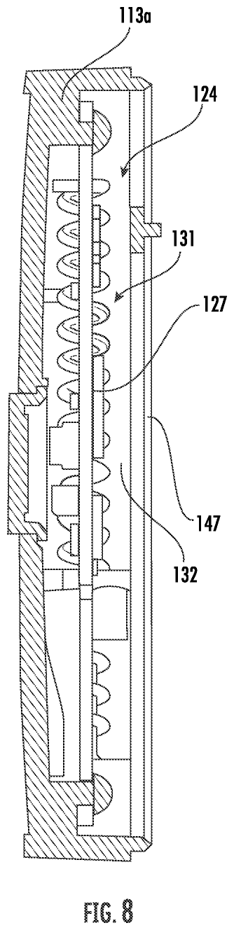

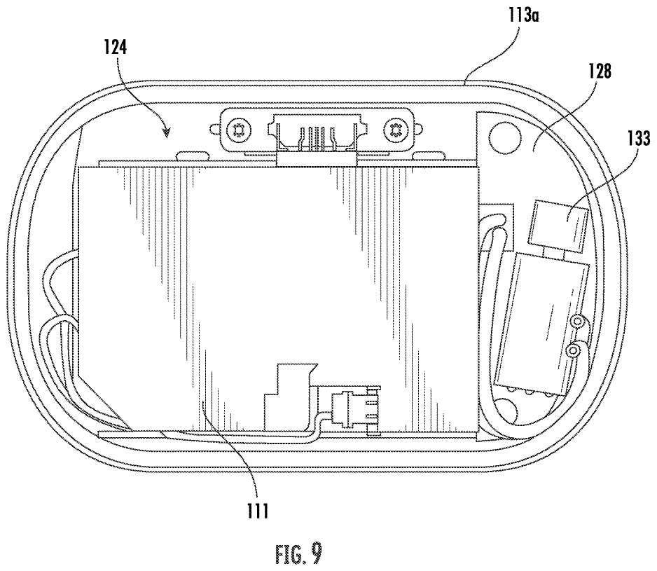

Referring now additionally to FIGS. 3-9, the animal collar device 105 illustratively includes a tracker circuit 124 carried by the first housing section 113a. The tracker circuit 124 comprises a circuit board 127 (e.g., a dielectric printed circuit board), a battery 111 carried by the circuit board, a processor 112 carried by the circuit board and coupled to the battery, a first coil antenna 131 carried by the circuit board and coupled to the processor, a second patch antenna 132 carried by the circuit board and coupled to the processor, an additional circuit board 128 (e.g., dielectric printed circuit board), and a haptic feedback motor 133 carried by the additional circuit board and coupled to the processor.

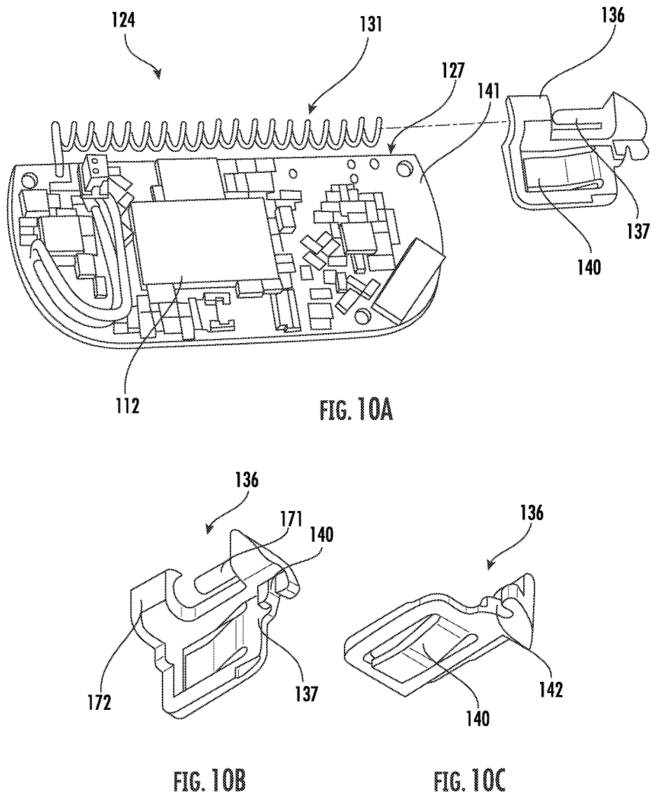

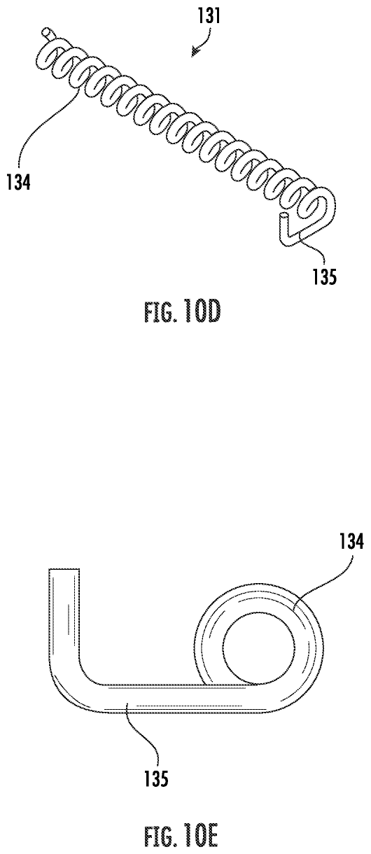

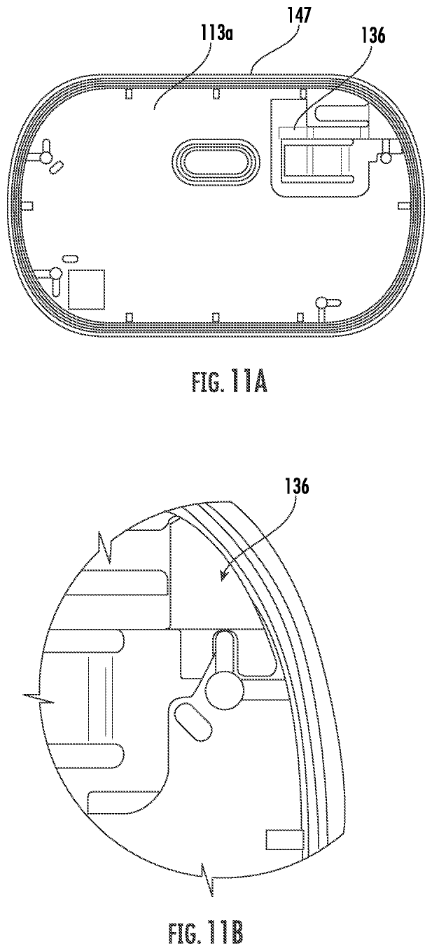

Referring now to FIGS. 10A-11B, the first coil antenna 131 illustratively includes an elongate coil segment 134, and a feed arm 135 coupled between the elongate coil segment and the processor 112. As will be appreciated, the first coil antenna 131 may comprise a geolocation receive antenna, for example, configured to receive signals from the GPS system.

The first coil antenna 131 also includes an antenna mount 136 coupled to the first housing section 113a. The antenna mount 136 may comprise a dielectric material, such as a plastic polymer material. The antenna mount 136 illustratively includes a cylindrical arm 137 extending within a distal portion of the elongate coil segment 134 opposite the feed arm 135. The antenna mount 136 also includes a clip interface 140 to engage a peripheral portion 141 of the circuit board 127.

As perhaps best seen in FIGS. 11A-11B, the antenna mount 136 also defines a retention slot 142 for receiving adjacent portions of the first housing section 113a. As will be appreciated, the retention slot 142 prevents the antenna mount 136 from rotating during operation, which would in turn rotate the elongate coil segment 134 and undesirably change receive characteristics of the first coil antenna 131.

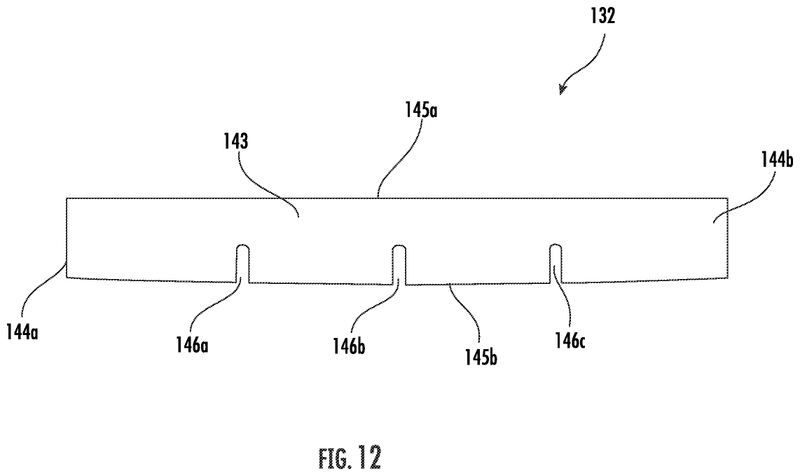

Referring now to FIG. 12, the second patch antenna 132 illustratively includes a primary conductive member 143 extending longitudinally and having opposing first and second ends 144a-144b. The primary conductive member 143 may comprise an electrically conductive material, for example, copper or aluminum. The second patch antenna 132 may comprise a wireless local area network (WLAN) antenna operable in one or more of several wireless standards, for example, cellular 5G/4G, Bluetooth, ZigBee, or low power high frequency. As will be appreciated, the second patch antenna 132 may provide a wireless connection to one or more of the mobile device 102 and the base station 104.

The primary conductive member 143 illustratively comprises first and second longitudinal sides 145a-145b extending between the first and second ends 144a-144b and being substantially parallel with each other (i.e., ±°10 of parallel). The second longitudinal side 145b defines a plurality of slots 146a-146c extending inwardly (40-60% of the total width between the first and second longitudinal sides 145a-145b) and transverse (e.g., substantially perpendicular to the second longitudinal side 145b, i.e., ±°10 of perpendicular) to the second longitudinal side. Each of the slots 146a-146c comprises substantially parallel sides (i.e., ±°10 of parallel), and a closed curved end. Also, the second longitudinal side 145b is convex curved in shape, and the first longitudinal side 145a is straight. The first and second ends 144a-144b are also straight and substantially parallel with each other (i.e., ±°10 of parallel).

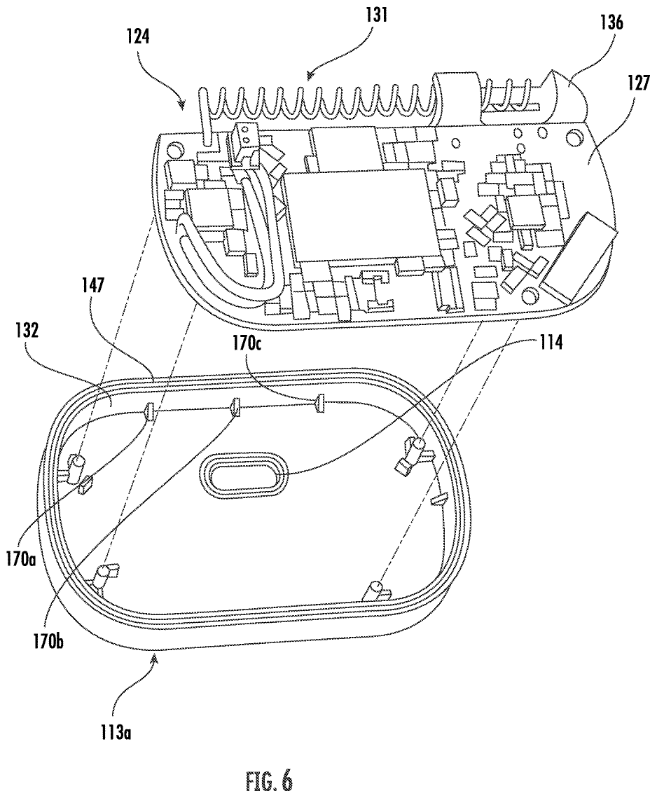

As perhaps best seen in FIG. 6, the second patch antenna 132 is coupled to the first housing section 113a along an upper peripheral wall 147. Also, the second patch antenna 132 is curved to fit the shape of the upper peripheral wall 147. In particular, the second patch antenna 132 is curved between the first end 144a and the first slot 146a, and the second end 144b and the third slot 146c.

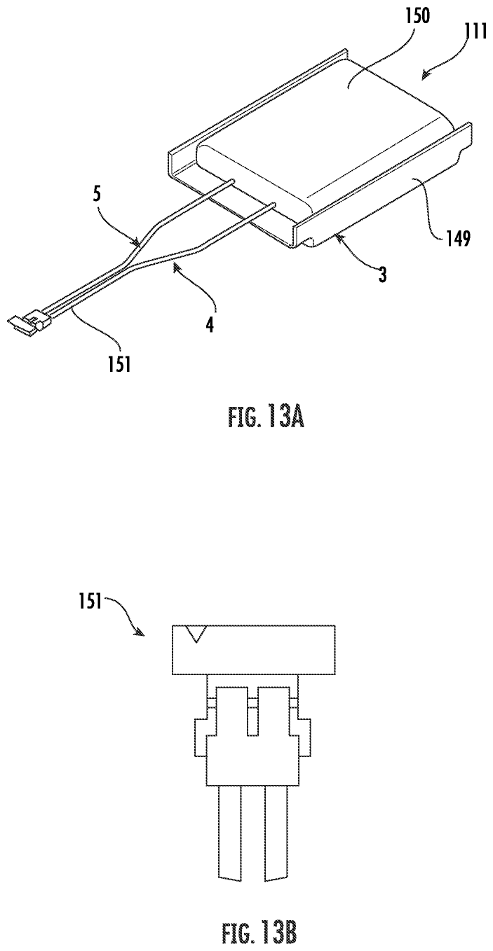

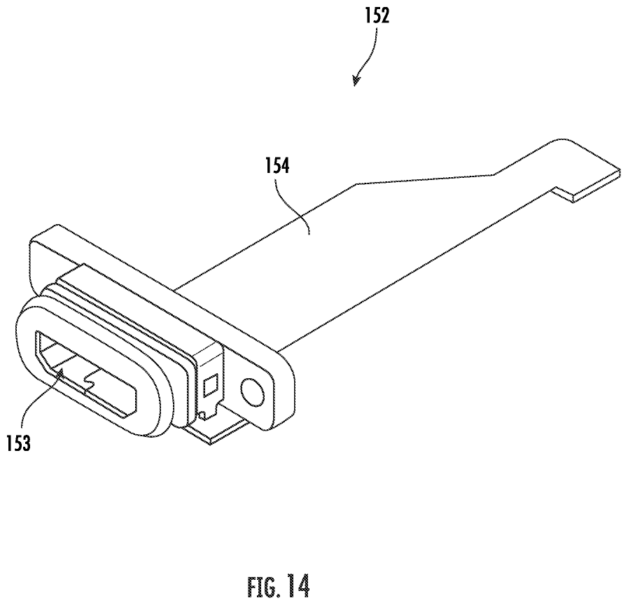

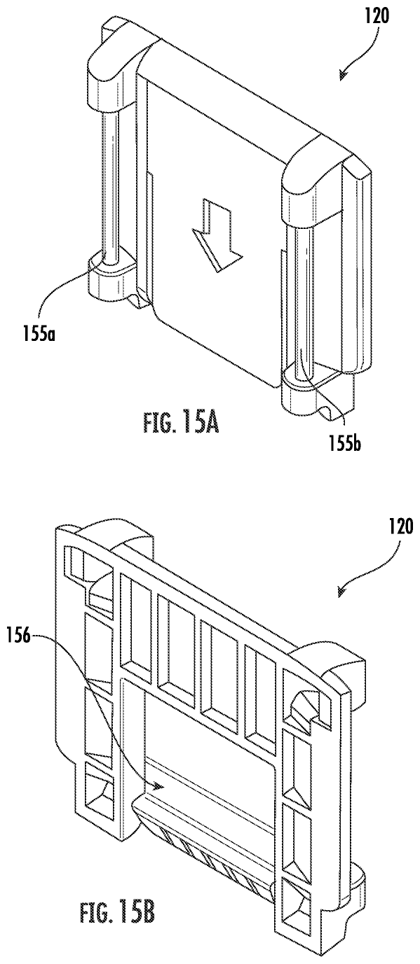

Referring now to FIGS. 13A-13B, the battery 111 comprises a battery housing 149, a sealed battery cell 150 (e.g., lithium ion battery cell) carried by the battery housing, and a connector 151 coupled thereto. The connector 151 comprises a female plug receptacle with two pin receiving openings, and a pair of connector wires coupled between the two pin receiving openings and respective terminals on the sealed battery cell 150.

Referring now to FIG. 14, the animal collar device 105 illustratively includes a charging connector 152 coupled to the tracker circuit 124. The charging connector 152 comprises a charging port 153, and a flexible connector layer 154 coupled between the tracker circuit 124 and the charging port. The charging port 153 is carried by the charging port opening 123. The flexible connector layer 154 comprises a flexible dielectric layer, and electrically conductive traces on the flexible dielectric layer defining a plurality of connector pads on a distal end thereof. As will be appreciated, the tracker circuit 124 may include a surface mount technology (SMT) connector for receiving the flexible connector layer 154.

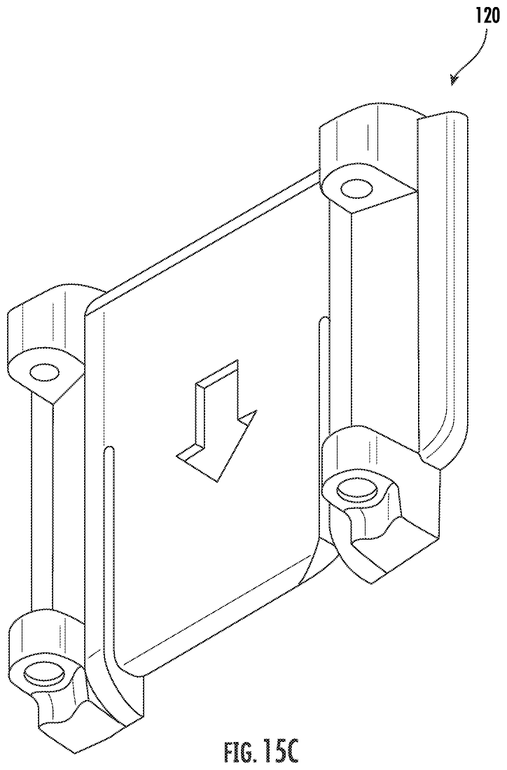

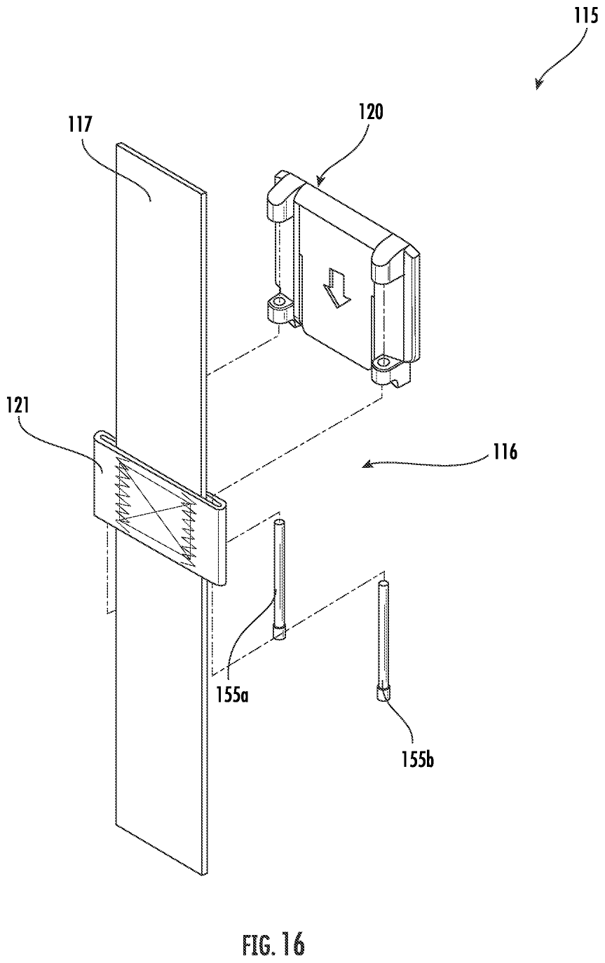

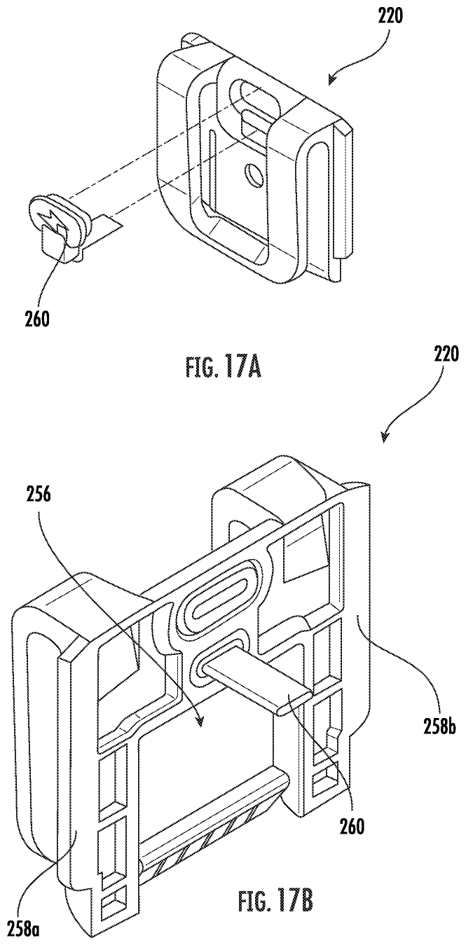

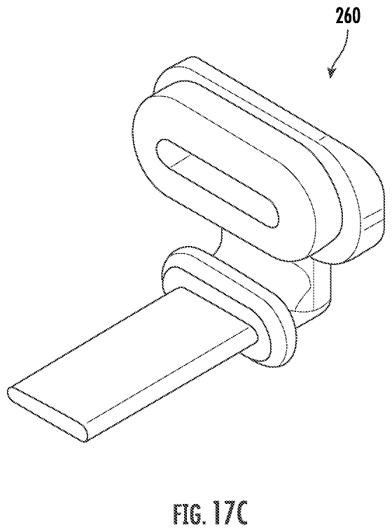

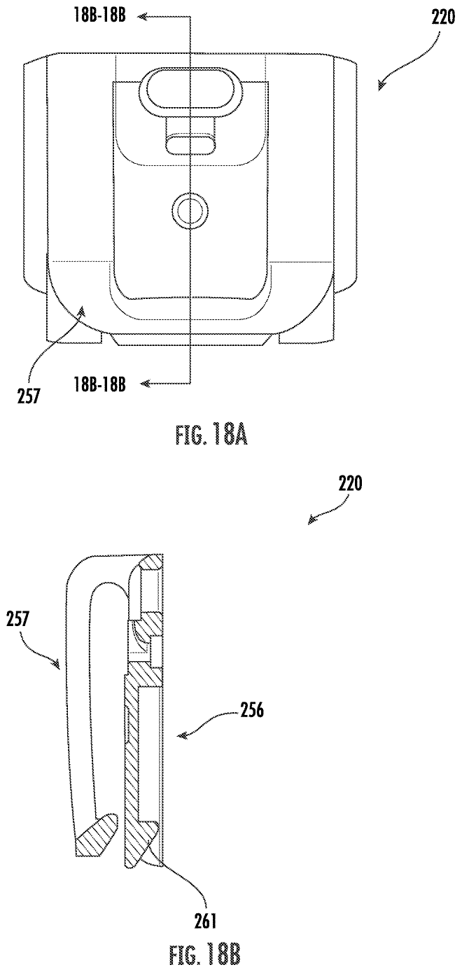

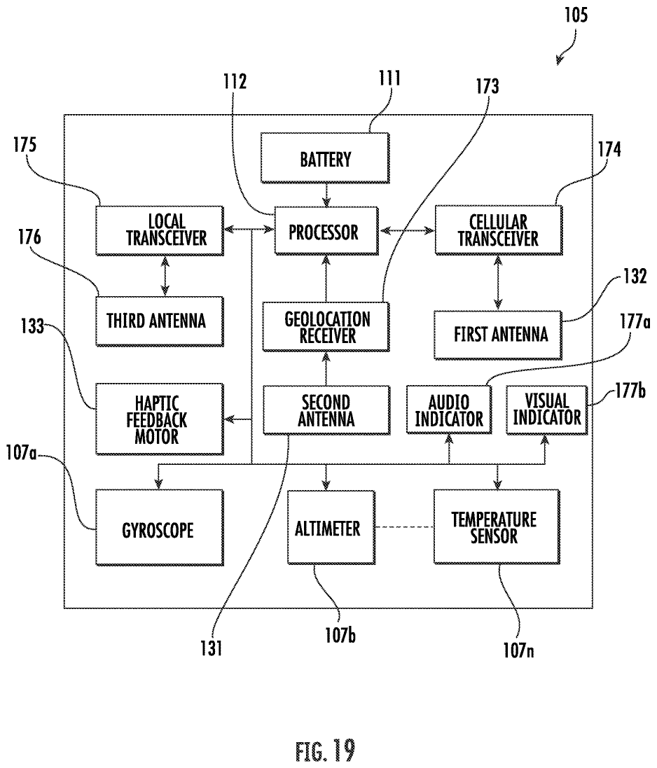

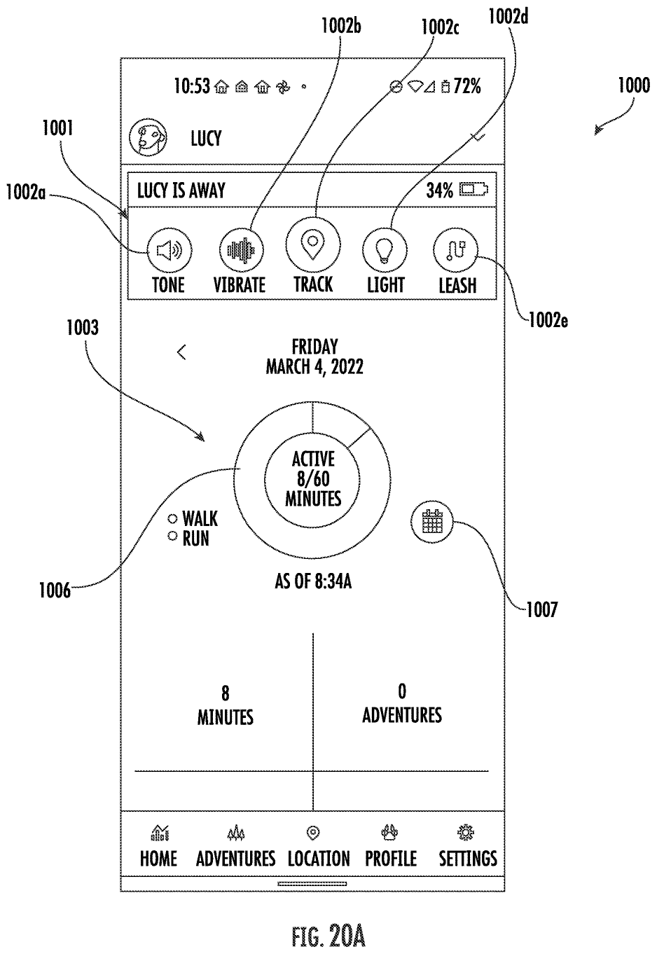

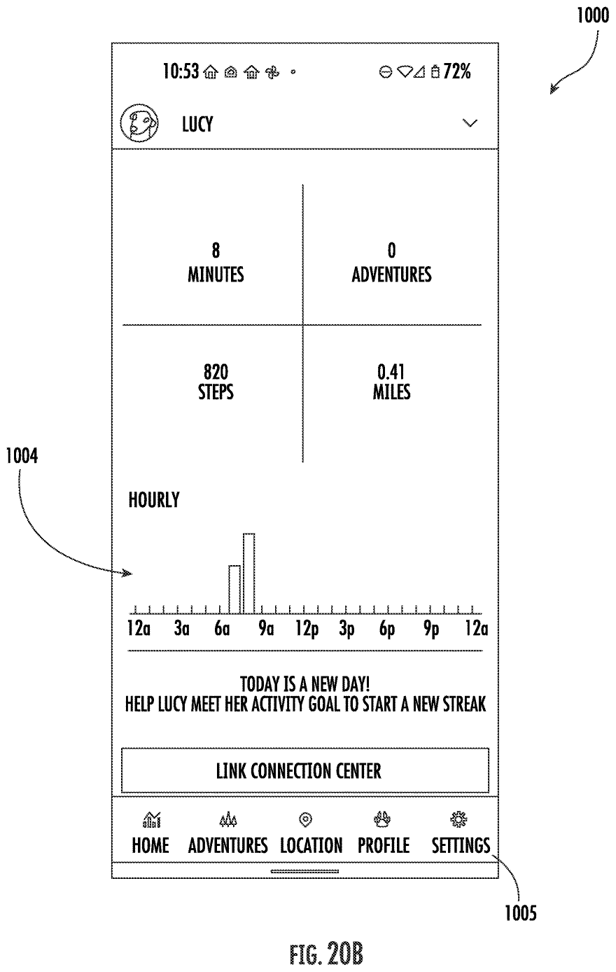

Referring now to FIGS. 15A-16, the collar assembly 115 comprises a retainer device 116, and a strap 117 extending through the retainer device and to wrap around the animal 101. The retainer device 116 comprises a base 120 coupling to the second housing section 113b and a retention arm 121 defining a slot to receive and retain the strap 117. The retention arm 121 illustratively includes first and second pins 155a-155b coupled at opposite ends of the base 120 and extending through passageways in the retention arm 121. In some embodiments, the retention arm 121 may comprise a fabric piece. The base 120 comprises a latch interface 156 for mechanically locking onto the interface 122 of the second housing section 113b.

Referring now additionally to FIGS. 17A-17B, another embodiment of the base 220 is now described. In this embodiment of the base 220, those elements already discussed above with respect to FIGS. 1-16 are incremented by 100 and most require no further discussion herein. This embodiment differs from the previous embodiment in that this base 220 illustratively includes a belt clip interface 257 for attachment to a collar of the animal 101. Here, the base 220 illustratively includes a cover 260 for the charging port.

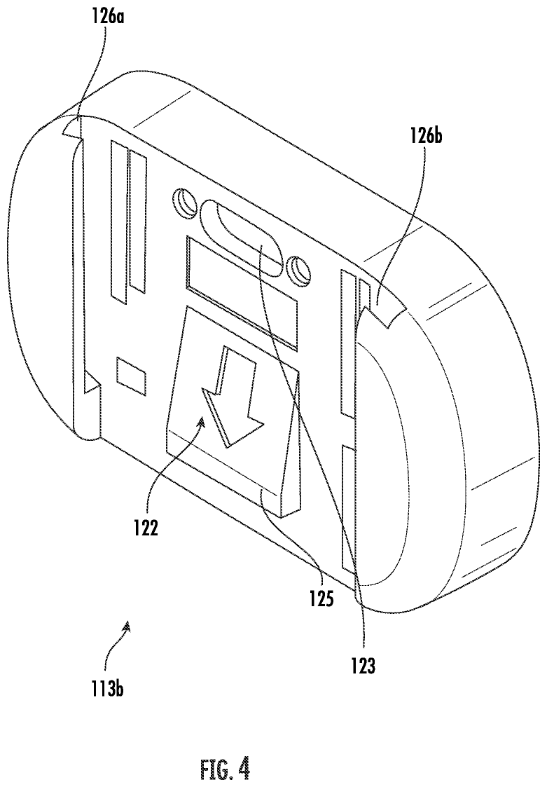

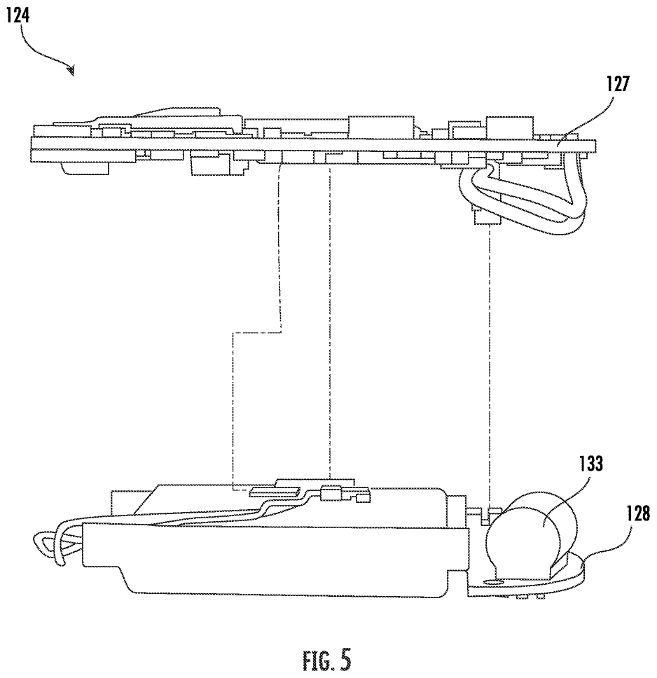

Referring again briefly and additionally to FIG. 4, the base 220 comprises a latch interface 256 for mechanically locking onto the interface 122 of the second housing section 113b. The latch interface 256 comprises a latch arm 261 to latch on the interface 122 of the second housing section 113b. In particular, the base 220 includes opposing first and second lateral ridges 258a-258b for respectively slidingly engaging the first and second opposing slots 126a-126b of the second housing section 113b. As this sliding action proceeds, the latch arm 261 engages the ramp 125 and elastically bends upward until a most distal portion of the latch arm 261 reaches the end of the ramp 125, which causes this latch arm to return to a non-flexed state, thereby latching onto the end of the ramp. It should be appreciated that the latching mechanism of the embodiment of the base 120 from FIGS. 15A-16 operates similarly.

Referring again to FIGS. 1-12 and now 19, an animal collar system 100 for monitoring an animal 101 (e.g., canine, cat) is now described. The animal collar system 100 illustratively includes a mobile device 102 associated with a user 103, a base station 104 (e.g., a WiFi base station, or a cellular base station), and an animal collar device 105.

The animal collar device 105 comprises a circuit board 127, a plurality of sensing components 107a-107n carried by the circuit board and configured to collect data about the animal 101, and a cellular transceiver 174 (e.g., 5G cellular wireless transceiver) coupled to the processor 112. The plurality of sensing components 107a-107n illustratively includes a gyroscope device 107a, an altimeter device 107b, and a temperature sensor 107n, for example. Of course, other embodiments may include other sensing components, such as a heart rate sensor.

The animal collar device 105 comprises a elongate patch antenna 132 carried by the circuit board 127 and coupled to the cellular transceiver. The elongate patch antenna 132 comprises an electrically conductive material, for example, one or more of aluminum, copper, silver, or gold.

The elongate patch antenna 132 comprises a first longitudinal side 145a and a second longitudinal side 145b opposing the first longitudinal side, and a first end 144a and a second end 144b opposing the first end. The first and second ends 144a-144b are between the first and second longitudinal sides 145a-145b. The second longitudinal side 145b illustratively includes a plurality of slots 146a-146c.

The animal collar device 105 include a processor 112 carried by the circuit board 127 and coupled to the plurality of sensing components 107a-107n and the elongate patch antenna 132. The processor 112 is configured to communicate the data about the animal 101 to the base station 104 and the mobile device 102.

The animal collar device 105 illustratively comprises a housing 113a-113b carrying the circuit board 127, the plurality of sensing components 107a-107n, the elongate patch antenna 132, and the processor 112. Each of the plurality of slots may comprise substantially parallel sides, and a curved end extending into the substantially parallel sides. In particular, the housing illustratively includes a first housing section 113a, and a second housing section 113b.

As perhaps best seen in FIG. 6, the elongate patch antenna 132 has a non-planar shape and is carried by the first housing section 113a. In particular, the first end 144a and the second end 144b each comprises a curved end. From a top plan view, the elongate patch antenna 132 is U-shaped. Also, it can be seen that the elongate patch antenna 132 abuts and follows the shape of the first housing section 113a. Moreover, the first housing section 113a illustratively includes a plurality of protrusions 170a-170c to extend respectively through the plurality of slots 146a-146c. As will be appreciated, this may prevent movement of the elongate patch antenna 132 during jarring movement from the animal 101.

The animal collar device 105 illustratively comprises a geolocation receiver 173 coupled to the processor 112, and a first coil antenna 131 coupled to the geolocation receiver and carried by the circuit board 127 and coupled to the processor 112. In some embodiments, the geolocation receiver 173 may comprise a GPS receiver. The first coil antenna 131 comprises an electrically conductive material, for example, one or more of aluminum, copper, silver, or gold. The first coil antenna 131 comprises an elongate coil segment 134, and a feed arm 135 coupled between the elongate coil segment and the processor 112. The first coil antenna 131 comprises an antenna mount 136 to be coupled to the circuit board 127. The antenna mount 136 comprises a retention arm 137 coupled to the circuit board 127 (i.e., retaining and clipping the circuit board), an inner antenna arm 171 extending from the retention arm and within the elongate coil segment 134, and an outer arm 172 extending from the retention arm and radially around the elongate coil segment. For example, the antenna mount 136 may comprise a dielectric material, such as a polymer plastic.

Further, the animal collar device 105 illustratively includes a haptic feedback motor 133 coupled to the processor 112. The haptic feedback motor 133 is configured to generate a mechanical indication to the animal 101 when desired. For example, during training, the haptic feedback motor 133 may be used to provide feedback to the animal 101 when correction is needed. Additionally, the animal collar device 105 illustratively includes an audio indicator 177a (e.g., a speaker) coupled to the processor 112 and configured to generate an audio alert (e.g., audio melody) to provide positive feedback to the animal 101 during training.

The animal collar device 105 illustratively includes a visual indicator 177b (e.g., an LED) coupled to the processor 112 and configured to generate a visual alert to provide positive/negative feedback to the animal 101 during training. Also, the visual indicator 177b may be configured to provide illumination when the animal 101 is traversing a dark area (e.g., when walking the animal at night).

The animal collar system 100 illustratively includes a local beacon 109, which comprises a beacon wireless transmitter configured to broadcast a beacon signal, and a beacon battery coupled to the wireless transmitter. In some embodiments, the beacon wireless transmitter comprises one or more of a Bluetooth wireless transmitter, and a ZigBee wireless transmitter. The animal collar device 105 includes a companion local wireless transceiver (or receiver) 175, and a third antenna 176 coupled thereto configured to receive the beacon signal. The processor 112 is configured to generate a received signal strength value for the beacon signal to provide a proxy value for a distance to the local beacon 109. The local beacon 109 may be positioned in a home of the user 103, and the processor 112 is configured to generate an alert indication (e.g., a text/chat/email message to the mobile device 102, or a notification message to the mobile device) when the distance to the local beacon 109 exceeds a threshold. In other words, when the animal 101 has left the home, the user 103 would be notified (i.e., acting as a virtual leash of sorts). In some embodiments, the processor 112 is configured to generate a corrective indication to the animal 101 when the distance to the local beacon 109 exceeds the threshold. For example, the processor 112 is configured to activate one or more of the haptic feedback motor 133, the audio indicator 177a, and the visual indicator 177b.

In some embodiments, the processor 112 is configured to cooperate with the local beacon 109 in a reverse fashion, in other words, providing a keep out zone for the animal 101. Here, the processor 112 is configured to generate the corrective indication to the animal 101 when the distance to the local beacon 109 is less than the threshold. For example, the local beacon 109 may be placed in the kitchen, and when the animal 101 approaches the kitchen, the corrective indication to the animal would guide the animal away.

Another aspect is directed to a method for operating an animal collar device 105 monitoring an animal 101. The animal collar device 105 is in communication with a mobile device 102 associated with a user 103 and a base station 104. The animal collar device 105 comprises at least one sensing component 107a-107n to be carried by a circuit board 127 and configured to collect data about the animal 101, and a elongate patch antenna 132 to be carried by the circuit board. The elongate patch antenna 132 comprises a first longitudinal side 145a and a second longitudinal side 145b opposing the first longitudinal side, and a first end 144a and a second end 144b opposing the first end. The first and second ends 144a-144b are between the first and second longitudinal sides 145a-145b, and the second longitudinal side comprises a plurality of slots 146a-146c. The method comprises operating a processor 112 to be carried by the circuit board 127 and to be coupled to the at least one sensing component 107a-107n and the elongate patch antenna 132, the processor configured to communicate the data about the animal 101 to the base station 104 and the mobile device 102.

Yet another aspect is directed to a method for making an animal collar device 105 for monitoring an animal 101 and in communication with a mobile device 102 associated with a user 103 and a base station 104. The method includes coupling a plurality of sensing components 107a-107n to be carried by a circuit board 127 and configured to collect data about the animal 101, and coupling a elongate patch antenna 132 to be carried by the circuit board and comprising a first longitudinal side 145a and a second longitudinal side 145b opposing the first longitudinal side, and a first end 144a and a second end 144b opposing the first end. The first and second ends 144a-144b are between the first and second longitudinal sides 145a-145b, and the second longitudinal side comprises a plurality of slots 146a-146c. The method includes coupling a processor 112 to be carried by the circuit board 127 and to be coupled to the plurality of sensing components 107a-107n and the elongate patch antenna 132, the processor configured to communicate the data about the animal 101 to the base station 104 and the mobile device 102.

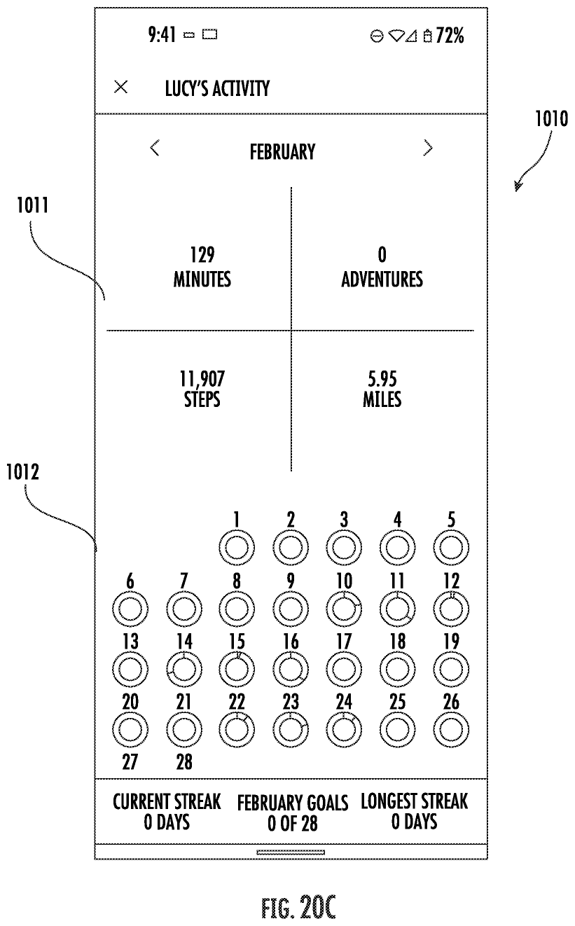

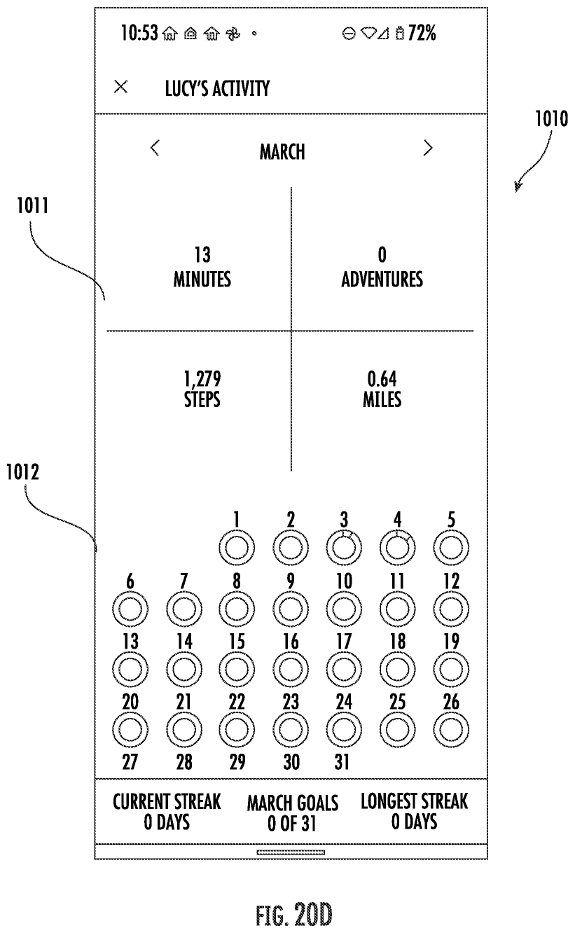

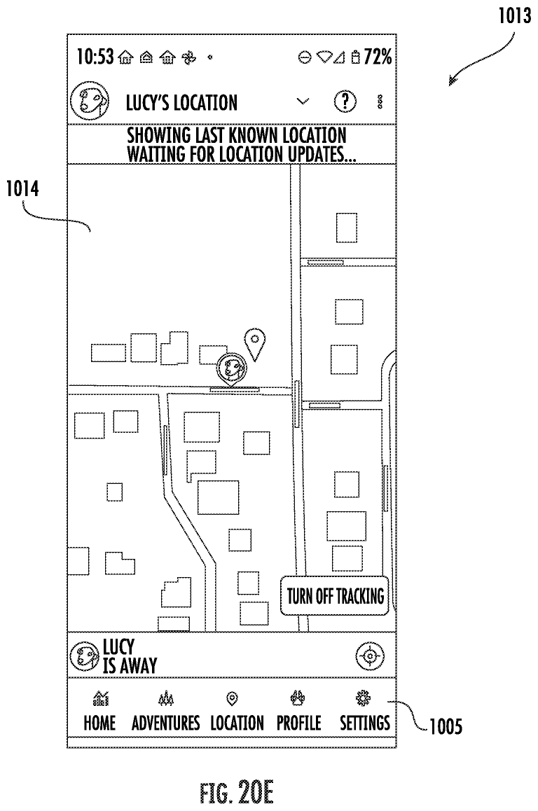

Referring now to FIGS. 20A-20E, an exemplary user interface for the mobile device 102 is shown. In some embodiments, the mobile device 102 is configured to execute a companion software application for the animal collar device 105. As will be appreciated, the companion software application may operate as a native mobile operating system application or a webpage application (e.g., Web 3.0). FIGS. 20A-20B include a home screen interface 1000 for the companion software application. The home screen interface 1000 illustratively includes a control ribbon interface 1001 having a plurality of quick access buttons 1002a-1002e. The plurality of quick access buttons 1002a-1002e comprises a tone button 1002a (activating the audio indicator 177a), a vibrate button 1002b (activating the haptic feedback motor 133), a track button 1002c (activating the geolocation receiver 173), a light button 1002d (activating the visual indicator 177b), and a leash button 1002e (activating the local transceiver 175 for detecting the local beacon 109). The home screen interface 1000 illustratively includes a daily summary interface 1003, an hourly summary interface 1004, and a lower ribbon interface 1005. The daily summary interface 1003 illustratively comprises a progress gauge 1006, and a calendar button 1007. When the calendar button 1007 is clicked, the companion software application transitions to a calendar interface 1010. The calendar interface 1010 illustratively comprises a monthly aggregate interface 1011, and a calendar interface 1012 for viewing respective data for days. The monthly aggregate interface 1011 comprises a plurality of data values (i.e., active minutes, steps, distance traveled, and adventures). Helpfully, the calendar interface 1012 includes respective gauges for how much activity has been registered for each day in the month.

When the track button 1002c is clicked, the companion software application transitions to a tracking interface 1013. The tracking interface 1013 illustratively comprises the same lower ribbon interface 1005, and a map interface 1014 showing a location of the animal collar device 105 via the geolocation receiver 173.

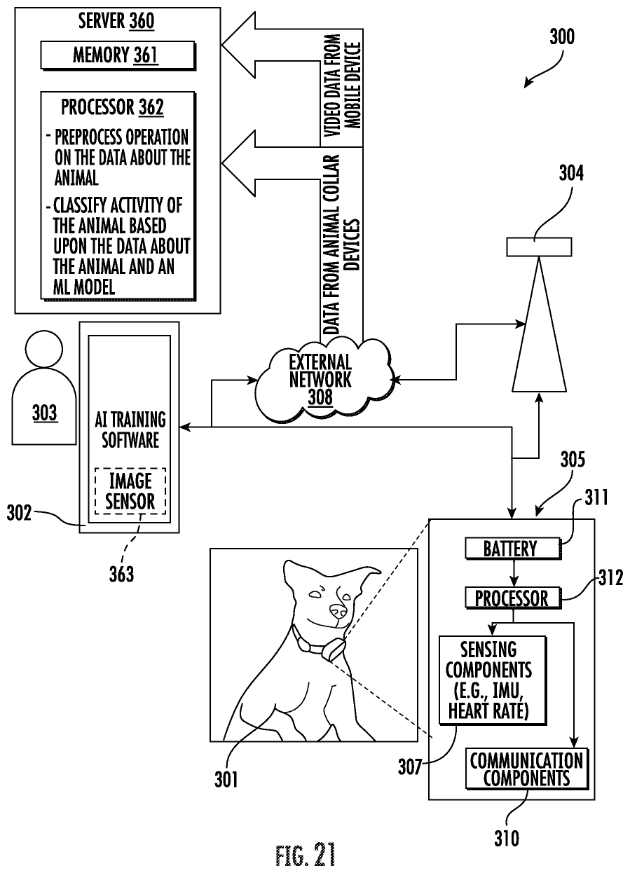

Referring now additionally to FIG. 21, another embodiment of the animal collar system 300 is now described. In this embodiment of the animal collar system 300, those elements already discussed above with respect to FIGS. 1-16 are incremented by 200 and most require no further discussion herein. This embodiment differs from the previous embodiment in that this animal collar system 300 illustratively includes a server 360 comprising a processor 361 and memory 362 coupled thereto. As will be appreciated, the server 360 may comprise one or more standalone computing devices or assigned resources on a cloud computing platform (e.g., Amazon Web Services, Microsoft Azure). The server 360 is configured to receive activity data from the animal collar device 305. For example, the activity data may comprise sensor values from the plurality of monitoring/sensing components 307. In this illustrated embodiment, the mobile device 302 comprises a local wireless transceiver (e.g., Bluetooth transceiver), and the animal collar device 305 is configured to transmit the activity data directly to the mobile device 302 via the local wireless transceiver, and the mobile device transmits the activity data to the server 360.

The server 360 is configured to process the activity data within an ML model. In particular, the ML model is trained with the activity data in conjunction with annotations (sourced in real time from the user 303) from the mobile device 302. The mobile device 302 illustratively comprises an image sensor 363 configured to generate video data of the animal 301 with related time data. As will be appreciated, the uploaded video data permits downstream annotation of the ML models output. The user 303 of the mobile device 302 may also include manual annotations of animal activities. The animal activities may include, for example, walking, running, resting, playing, eating, chewing, scratching, barking, rolling, and digging. The video data and the time data are transmitted to the server 360, and the server is configured to synchronize the video data from the mobile device 302 with the activity data from the animal collar device 305.

The ML model is configured to be trained using the synchronized video data, the activity data, and the user 303 annotations (collectively “training data”). In some embodiments, the user 303 carries a wearable device (e.g., pedometer, smart watch, smart wearable) configured to generate user activity data. The server 360 may be configured to train the ML model also using the user activity data. Also, in some embodiments, the mobile device 302 may provide additional geospatial data from the onboard geolocation device within the training data. As will be appreciated, the geospatial data from the mobile device 302 may be more accurate, and may replace the collar geospatial data to reduce battery power consumption on the animal collar device 305.

The first step of the data processing is for the training data to be graded and classified. In particular, the training data is graded to determine whether there are holes in the data for some time periods; and the training data is graded depending on whether the user 303 included characteristic data for the animal 301 (e.g., dog breed, weight, age) and identification information. Activity data of low quality may be excluded from the training data.

The server 360 is configured to perform an initial analysis of the training data. In particular, the training data is plotted on a data waveform, and the waveform is segmented into activity periods, each period assigned an at least one activity type. The server 360 then runs the training data into the ML model, and the ML model generates activity types from the training data. The generated activity types are now annotated with correct classification, which is also fed into the ML model to provide supervised learning.

More specifically, the server 360 may be configured to perform a pre-process operation on the data about the animal 301. The pre-process operation comprises processing the data about the animal 301 in a plurality of windows for the data about the animal. The pre-process operation includes generating a plurality of variables (i.e., input features for the ML model) for each of the plurality of windows. For example, the plurality of variables may comprise a mean value, a number of zero crosses, a statistical variance, an energy value, a peak-to-peak value, a minimum value, and a maximum value. The server 360 is configured to ingest the plurality of variables for each of the plurality of the windows into the ML model.

The server 360 is configured to operate the ML model to classify an activity of the animal 301 for each of the plurality of windows. The pre-process operation comprises classifying the data about the animal 301 based upon at least one of an animal type, an animal breed, and an animal age.

In some embodiments, the mobile device 302 may be configured to generate video data of the animal 301. The video data of the animal 301 may be concurrent in time or even contemporaneous with the data about the animal. The server 360 may be configured to plot the data about the animal 301 on a waveform, and segment the waveform based upon the video data of the animal.

Also, the plurality of sensing components 307 may comprise an IMU configured to generate motion data. The server may be configured to filter the motion data. For example, the filtering may comprise one or more of a low pass filter, a high pass filter, or a Butterworth filter. The activity of the animal may comprise a plurality thereof, the plurality of activities comprising barking, sleeping, walking, and running, for example.

Another aspect is directed to a method for monitoring an animal 301 with an animal collar system 300 comprising a mobile device 302 associated with a user 303, a server 360 coupled communicating with the mobile device over a network 304, and an animal collar device 305 associated with the animal. The method comprises operating a local wireless transceiver 310 in the animal collar device 305 to communicate with the mobile device 302, and operating a plurality of sensing components 307 in the animal collar device to collect data about the animal 301. The method also includes operating a processor 312 in the animal collar device to transmit the data about the animal 301 to the mobile device 302. The mobile device 302 is configured to transmit the data about the animal 301 to the server 360 over the network 304, and operating the server to classify at least one activity of the animal based upon the data about the animal and a ML model.

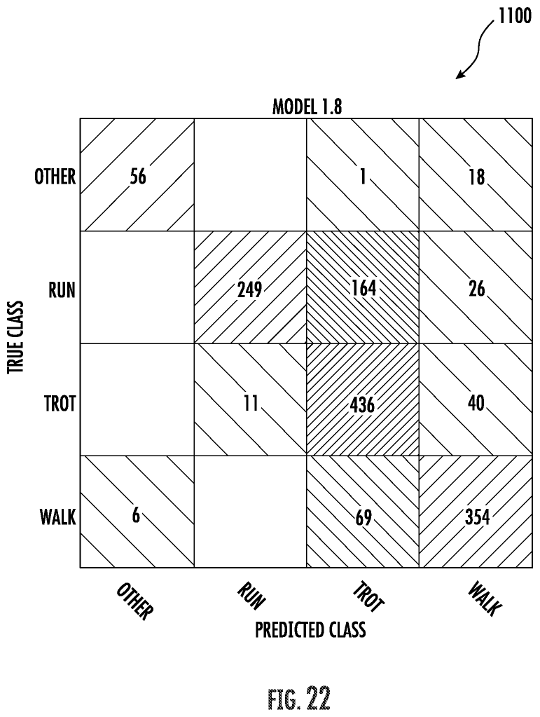

As shown in FIG. 22, a confusion matrix 1100 is generated to gauge how well the ML model is performing. The confusion matrix 1100 represents an overall picture of how well the ML model performs. In particular, the confusion matrix 1100 plots correct predictions versus actual activity, and provides output on what activities the ML model is classifying well and classifying poorly. As will be appreciated, the diagonal line (top left to top right) of dashed boxes represents optimum results. The long dash-short dash boxes represent less than optimum results.

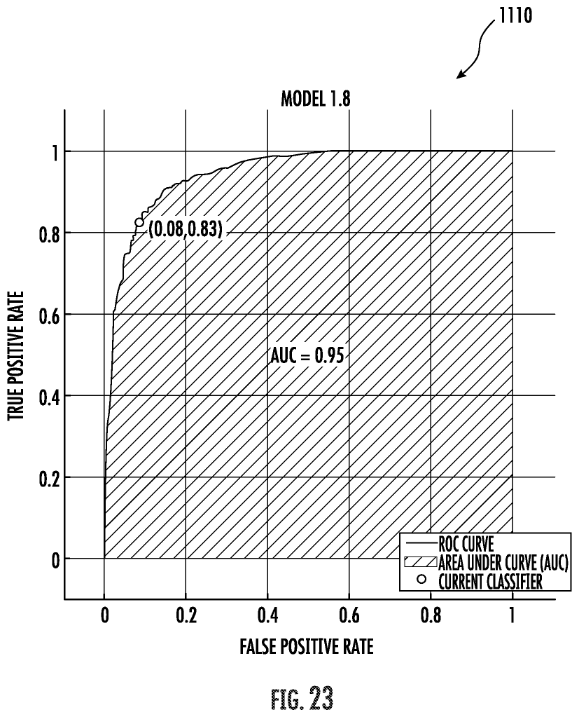

As shown in FIG. 23, a diagram 1110 shows a receiver operating characteristic (ROC) curve. The ROC curve shows the quality of an individual activity type, and how well the ML model can discriminate it from others. The ROC curve plots true positives against false positives. In determining why an activity type is inaccurately identified, the ROC curve shows whether it is over predicted by the ML model or whether other activities are wrongly classified.

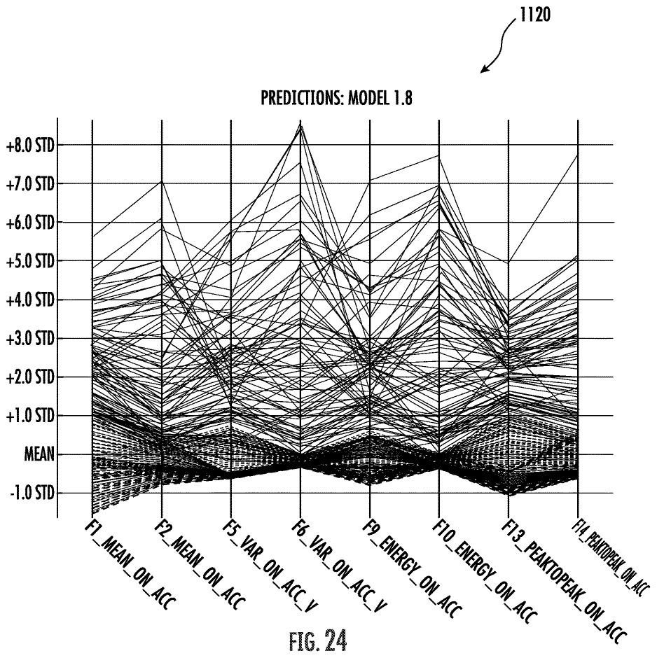

As shown in FIG. 24, a diagram 1120 shows a parallel coordinates plot. The parallel coordinates plot shows how accurate input variables are in relation to predicting the final activity type. The input variables include accelerometer and gyroscope data and various window functions applied to the data (e.g., mean, peak-to-peak, and more). This diagram 1120 may be used to eliminate variables that don't contribute significantly to the classification.

In the next phase, the server 360 is configured to perform some testing using the training data. In particular, a subset of the training data is reserved for testing. In other words, the reserved data is carved out and not used for training. Rather, the reserved data is used to validate the ML model after it has been trained.

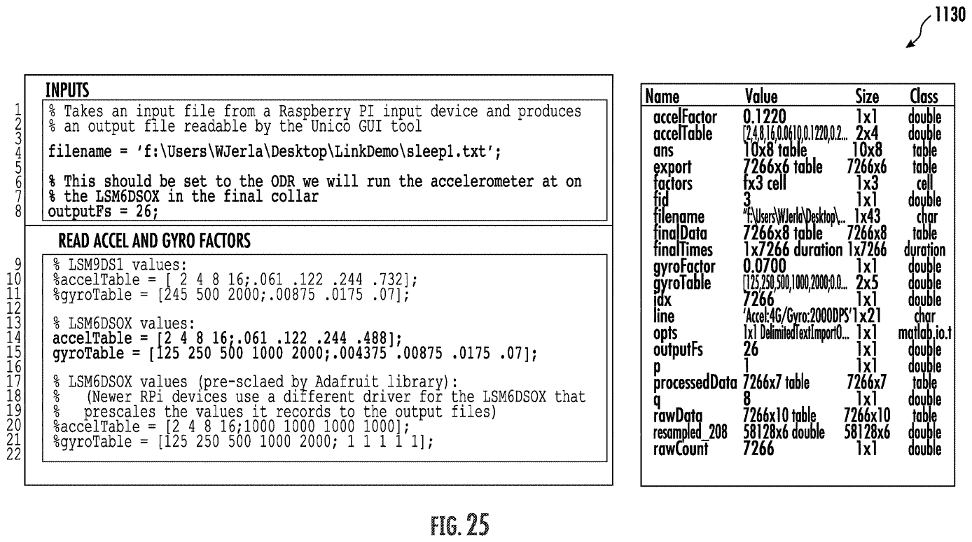

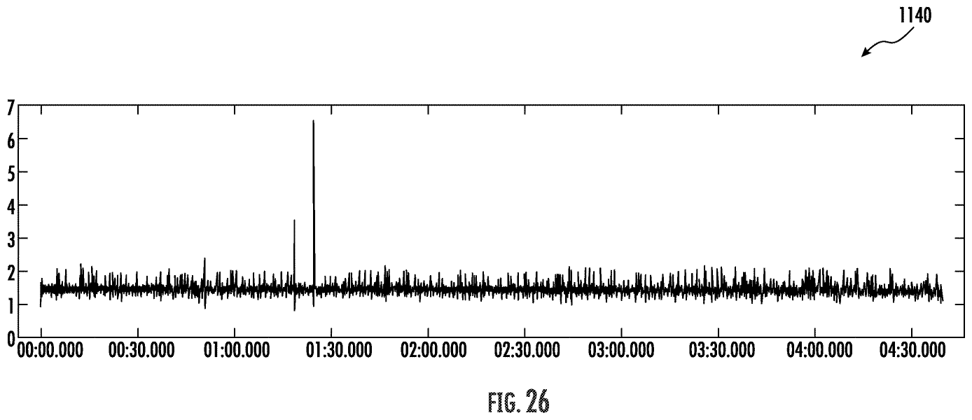

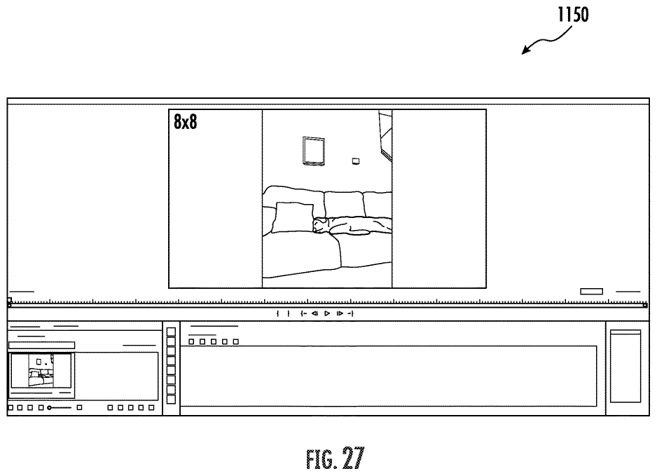

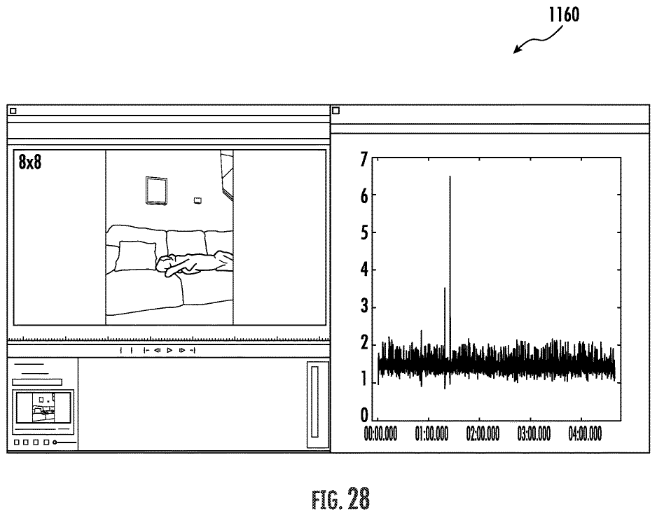

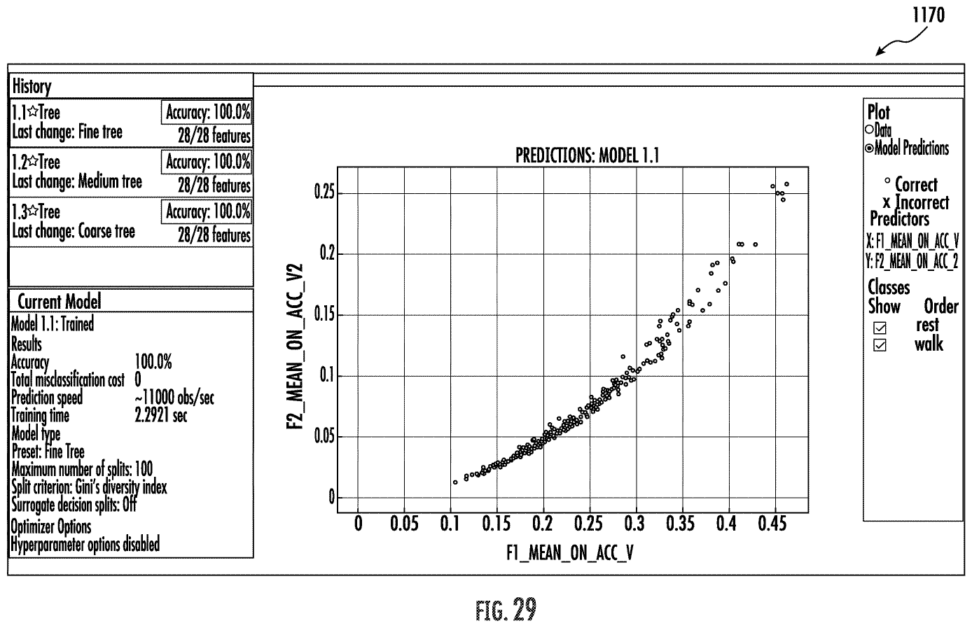

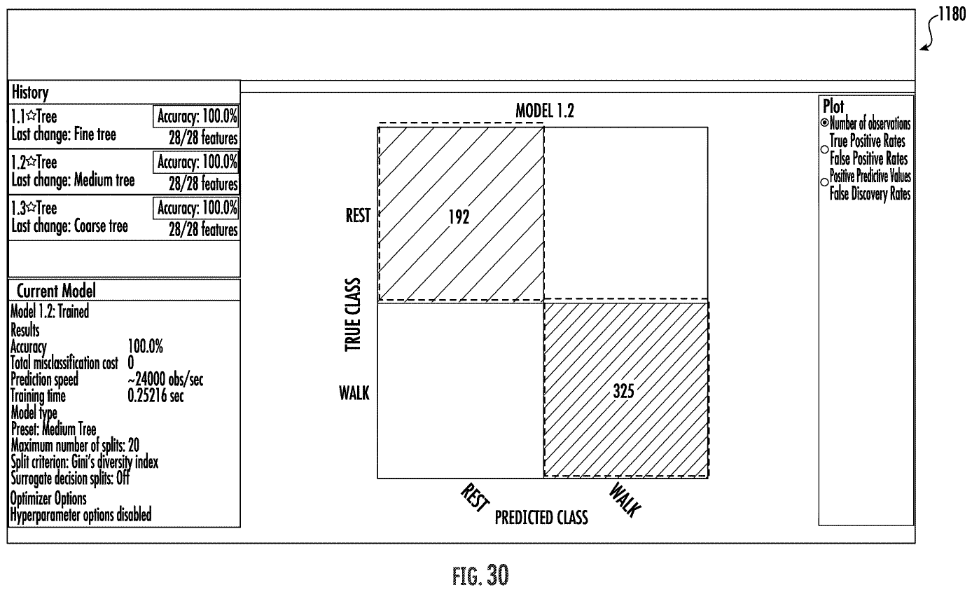

Referring now additionally to FIGS. 25-30, an exemplary embodiment of the training method is now described. In screenshot 1130, the training data from the animal collar device 305 is received. In the central data panel, the raw data types are displayed. In the command panel, the instruction to create a diagram 1140 is executed. Screenshot 1150 shows the associated video data of the animal 301 sleeping. Of course, since the animal 301 is not moving, the diagram 1140 includes a nearly flat plot line. In screenshot 1160, the video data can be searched to find the cause of the spike in the diagram 1140, which shows the animal 301 moving briefly while sleeping. For improved training, the aberration in the training data can be removed, which provides a better data set. In other words, using the contemporaneous video data, the anomalous data can be removed to provide for more efficient training of the ML model.

In some embodiments, the training data can be subjected to filters to remove extraneous data. In particular, the data from the gyroscope sensor may be subjected to low pass filter at 10 Hz, removing data indicating the animal 301 is walking more than 10 steps a second.

The ML model classifies the training data over a set time period. For example, if the set time period is 1 second, the ML model will classify the activity type every second (e.g., walking, running, resting, playing, eating, chewing, scratching, barking, rolling, and digging). In screenshot 1170, the training data is ingested into the ML model, and for each set period, the ML model provides a classification of the animal activity. In the screenshot 1170, a scatter plot is provided showing the predicted classifications, and screenshot 1180 includes an associated confusion matrix.

In particular, the ML model may operate based upon a supervised training ML approach using a decision tree learning model. For example, the decision tree learning model may comprise a classification tree. In some embodiments, the server 360 may additionally feed the training data into an anomaly detection ML model. The anomaly detection ML model may alert the user 303 to anomalies in the training data that may indicate a medical issue with the animal. For example, the anomaly detection ML model may comprise a neural network ML model.

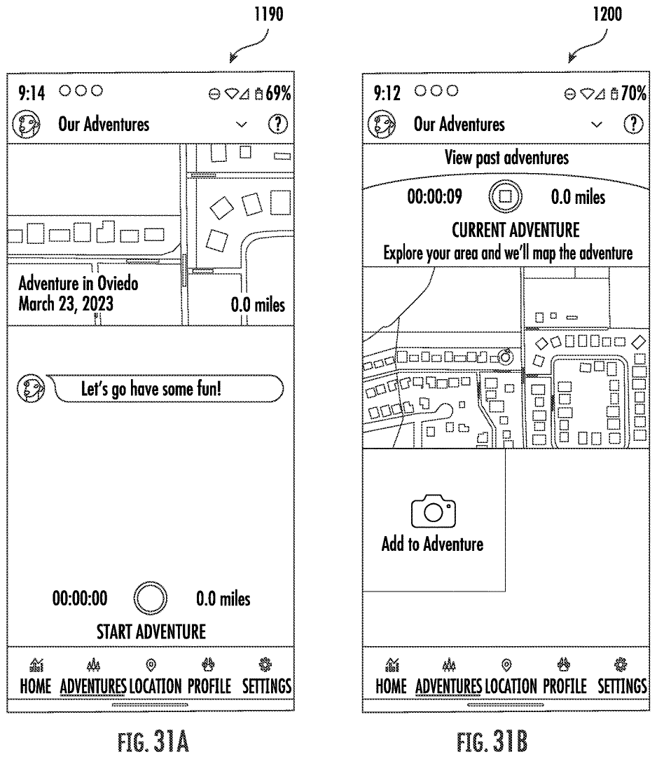

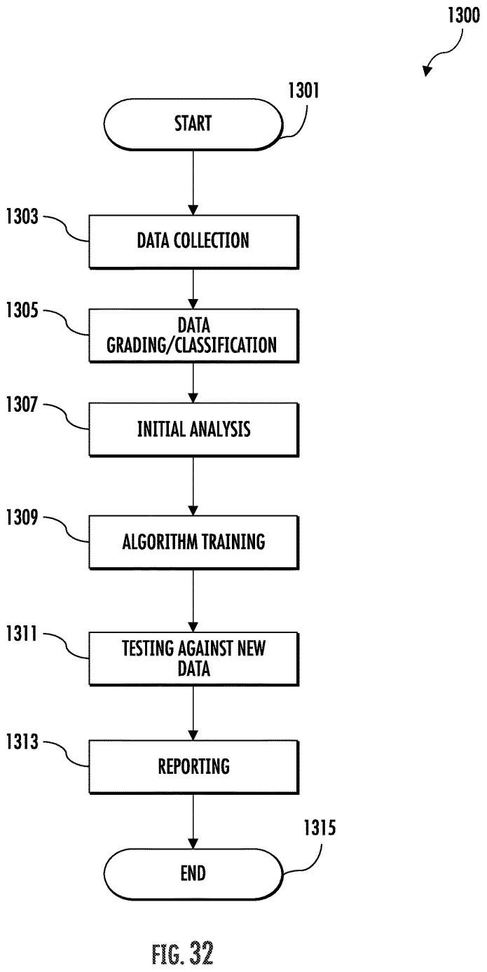

Referring now additionally to FIGS. 31A-31B, an exemplary embodiment of the software on the mobile device 302 is now described. When the user 303 wishes to create training data, the user accesses the adventure submenu (screenshot 1190) from the bottom menu. The user 303 may view past training sessions in this menu, and the adventure submenu also includes a start adventure button. Once the user 303 starts the training session, the menu transitions to the training data submenu (screenshot 1200). This training data submenu includes an option to capture video data, and the geospatial data from the mobile device 302 is also displayed.

Referring now additionally to FIG. 32, with reference to a flowchart 1300, the high level operation of the ML model described hereinabove is described, which begins at Block 1301. The operation of the ML model comprises a data collection step at Block 1303. In the data collection step, data is collected by trained users using animal collar devices 305 and a cell phone application on the mobile device 302. The animal collar device 305 is placed in a special data collection mode and raw data is streamed to the mobile device 302. Once collection is complete, the data is uploaded to the server 360. Also, a video of the activity is also recorded by the user 303 and uploaded to the server 360.

At Block 1305, the operation of the ML model comprises a data grading and data classification step. Here, the data is graded for quality (e.g., are there any holes in the data?). The information about dog size, breed, and age is associated to the data, and identifying information is not collected.

At Block 1307, the operation of the ML model comprises an initial analysis step. Here, the data waveform is visually plotted, and using the video of the activity, plotted data is segmented into specific activities (e.g., walking, running, etc.). Once the activities are known, we run the new data through the existing algorithm to see how it performs.

At Block 1309, the operation of the ML model comprises an algorithm training step. Here, the data for the activities we are interested in is pre-processed through an ML tool. Then, MATLAB is then used to run machine learning algorithms on the data. This is an iterative process, with feedback from a training run used to adjust and improve the next run.

Here, this testing represents an overall picture of how well the algorithm performs, and plots correct predictions versus actual activity. For example, as shown in the confusion matrix 1100 of FIG. 22, the perfect algorithm would be a diagonal of dashed blocks. This allows us to see what activities the ML model classifies well, and less than optimum.

With reference to the ROC curve in the diagram 1110 of FIG. 23, this shows the quality of an individual activity: how well the ML model can discriminate it.

This plots true positives against false positives, and this shows why an activity isn't accurate: is it because of over-prediction this one, or are other activities wrongly classified.

With reference to the parallel coordinates plot in the diagram 1120, this shows how accurate input variables are in relation to predicting the final activity. The variables include accelerometer, gyroscope data and various window functions applied to the data (i.e., mean, peak-to-peak, and more). This can be used to eliminate variables that don't contribute significantly to the classification. At Block 1311, the operation of the ML model comprises a testing step. At Block 1313, the operation of the ML model comprises a reporting step. The operation ends at Block 1315.

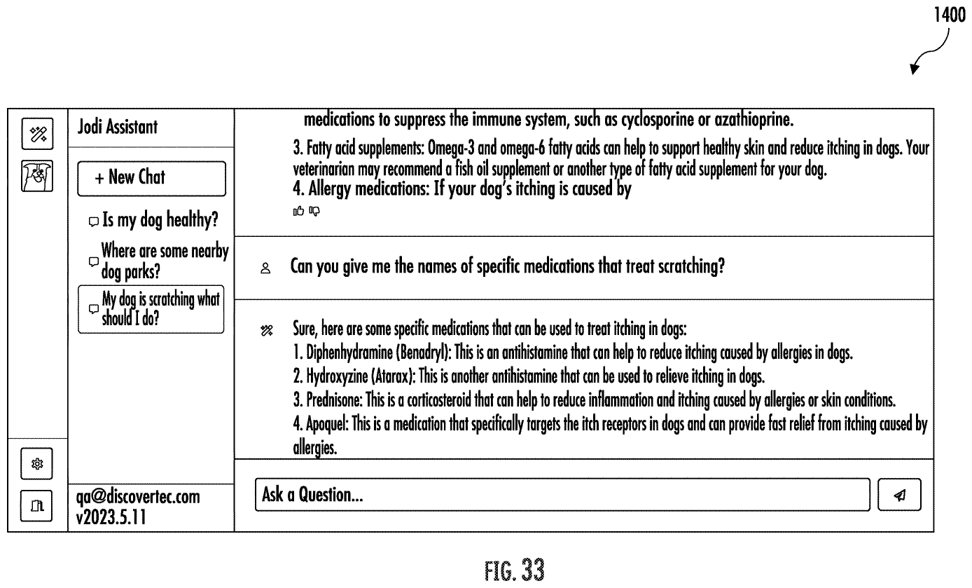

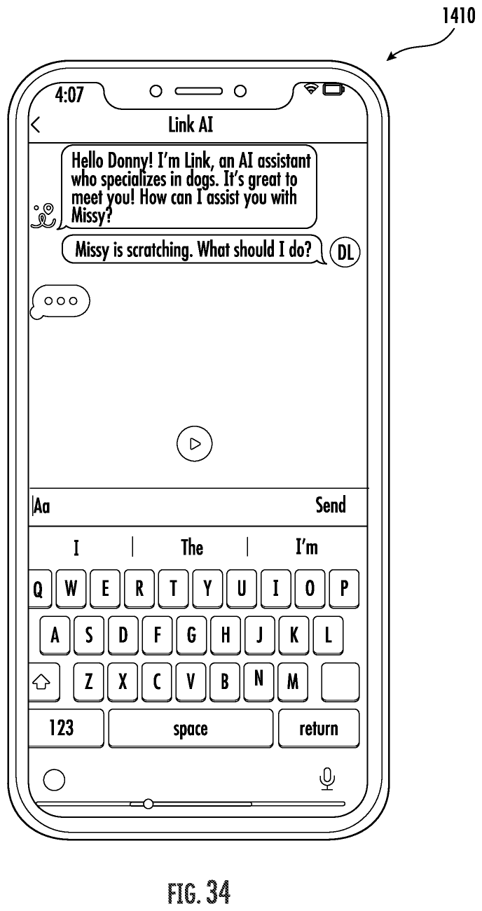

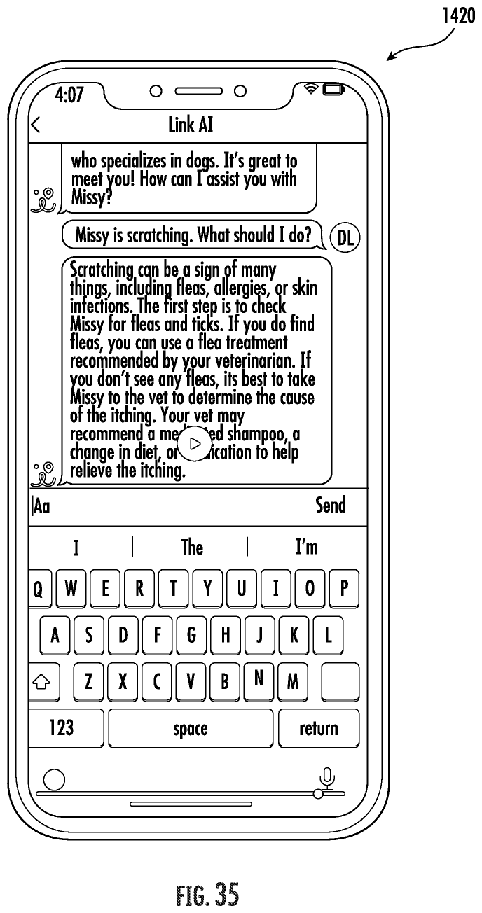

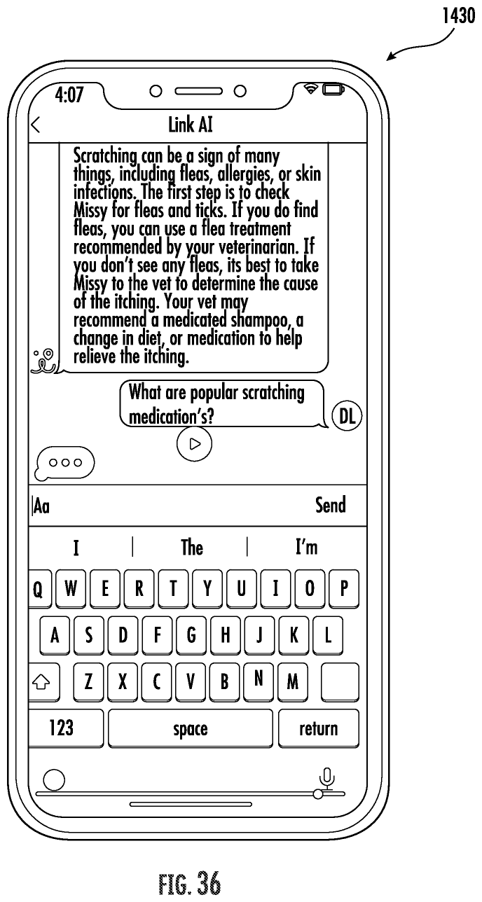

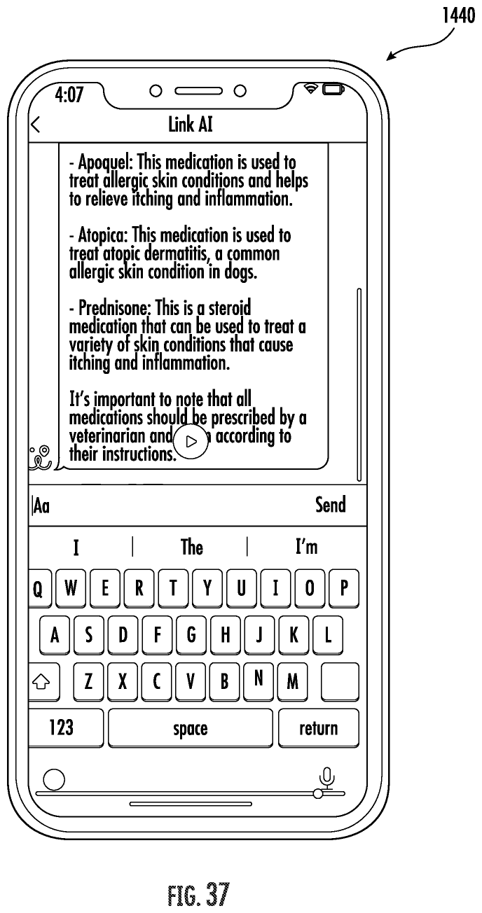

In some embodiments, the server 360 may operate a generative artificial intelligence (GAI) system. The user 303 may access the GAI via a chat interface provided via a chat interface shown screenshots 1400, 1410, 1420, 1430, 1440 in FIGS. 33-37. As shown in this illustrative example, the GAI system is prompted with a medical inquiry regarding the animal 301. The user 303 may access the GAI system via a mobile application on the mobile device 302. Further, the GAI system has access to the historical data collected about the animal 301 from the animal collar device 305. In some embodiments, the GAI system has access to practice information management software (PIMS) for the veterinarian of the animal 301. For example, if the animal 301 is allergic to a certain medication, the GAI system will have this data point from the veterinary record of the animal and not recommend the medication in response to medical inquiries from the user 303.

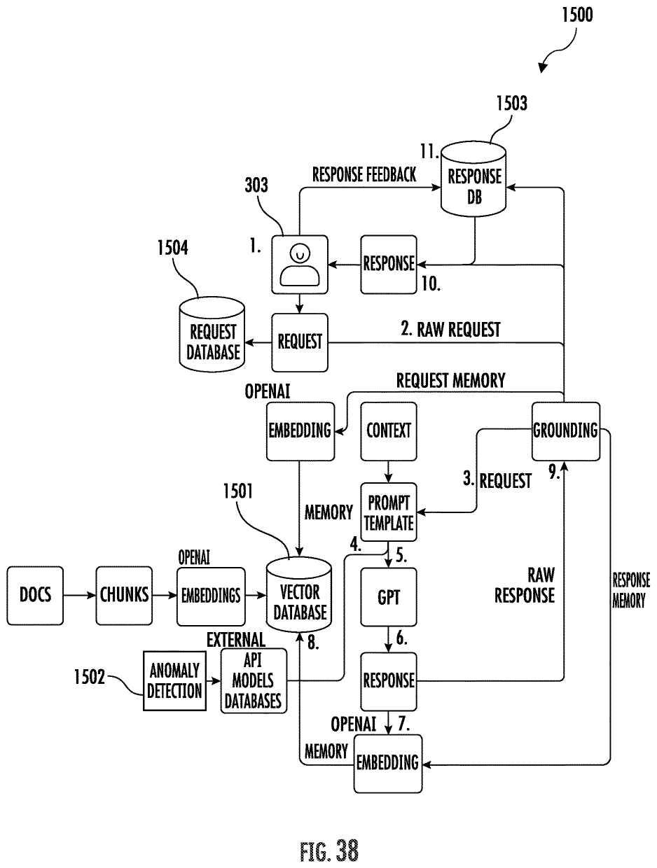

Referring to FIG. 38, a diagram 1500 shows the architecture of the ML model and GAI described herein above. Broadly, the architecture includes data processing, training, testing, inference, evaluation, and optimization. The large language model (LLM) is sourced from ChatGPT, for example. The architecture includes a vector database 1501 for storing request/response memory, which gives the ML model context and a cache to reuse stored responses for stored similar requests.

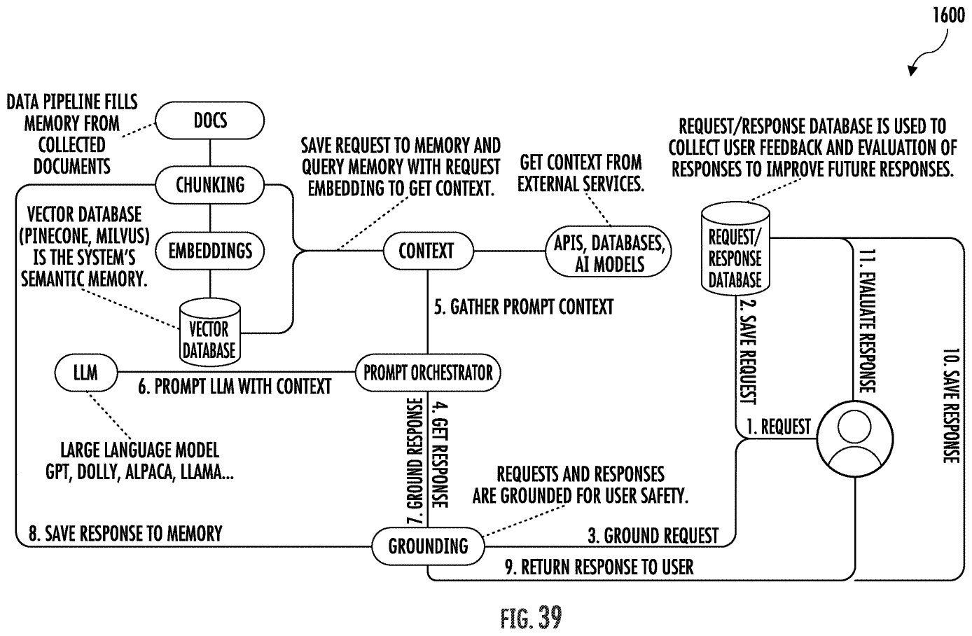

The architecture also includes an anomaly detection module 1502, a response memory module 1503 for getting answers from external system and to refine responses from ChatGPT, and a request database 1504 for storing prior requests. Referring to FIG. 39, a diagram 1600 shows the architecture flow of the ML model and GAI described herein above.

It should be appreciated that the features of the animal collar system 100 and the animal collar system 300 are interchangeable between each system. The features of one of the animal collar system 100 and the animal collar system 300 can be removed, and/or combined with features from the other animal collar system.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

1. An animal collar system for monitoring an animal, the animal collar system comprising:
a mobile device associated with a user;
a server coupled communicating with the mobile device over a network; and
an animal collar device associated with the animal and comprising
a circuit board,
a local wireless transceiver carried by the circuit board and configured to communicate with the mobile device,
a plurality of sensing components carried by the circuit board and configured to collect data about the animal, and
a processor carried by the circuit board and coupled to the local wireless transceiver and the plurality of sensing components, the processor configured to transmit the data about the animal to the mobile device, the mobile device configured transmit the data about the animal to the server over the network;
the server configured to classify at least one activity of the animal based upon the data about the animal and a machine learning (ML) model.

2. The animal collar system of claim 1 wherein the server is configured to perform a pre-process operation on the data about the animal, the pre-process operation comprising processing the data about the animal in a plurality of windows for the data about the animal.

3. The animal collar system of claim 2 wherein the pre-process operation comprises generating a plurality of variables for each of the plurality of windows, the plurality of variables comprising a mean value, a number of zero crosses, a statistical variance, an energy value, a peak-to-peak value, a minimum value, and a maximum value; and wherein the server is configured to ingest the plurality of variables for each of the plurality of the windows into the ML model.

4. The animal collar system of claim 2 wherein the server is configured to operate the ML model to classify the at least one activity of the animal for each of the plurality of windows.

5. The animal collar system of claim 2 wherein the pre-process operation comprises classifying the data about the animal based upon at least one of an animal type, an animal breed, and an animal age.

6. The animal collar system of claim 1 wherein the mobile device is configured to generate video data of the animal, the video data of the animal being concurrent with the data about the animal.

7. The animal collar system of claim 6 wherein the server is configured to plot the data about the animal on a waveform, and segment the waveform based upon the video data of the animal.

8. The animal collar system of claim 1 wherein the plurality of sensing components comprises an inertial measurement unit (IMU) configured to generate motion data.

9. The animal collar system of claim 8 wherein the server is configured to filter the motion data.

10. The animal collar system of claim 1 wherein the at least one activity of the animal comprises a plurality thereof, the plurality of activities comprising barking, sleeping, walking, and running.

11. An animal collar system for monitoring an animal, the animal collar system comprising:
a server coupled communicating with a mobile device over a network; and
an animal collar device associated with the animal and comprising
a circuit board,
a local wireless transceiver carried by the circuit board and configured to communicate with the mobile device,
a plurality of sensing components carried by the circuit board and configured to collect data about the animal, and
a processor carried by the circuit board and coupled to the local wireless transceiver and the plurality of sensing components, the processor configured to transmit the data about the animal to the mobile device, the mobile device configured transmit the data about the animal to the server over the network;
the server configured to
perform a pre-process operation on the data about the animal, the pre-process operation comprising
processing the data about the animal in a plurality of windows for the data about the animal,
generating a plurality of variables for each of the plurality of windows, and
ingest the plurality of variables for each of the plurality of the windows into a machine learning (ML) model, and
classify at least one activity of the animal based upon the data about the animal and the ML model.

12. The animal collar system of claim 11 wherein the plurality of variables comprises a mean value, a number of zero crosses, a statistical variance, an energy value, a peak-to-peak value, a minimum value, and a maximum value.

13. The animal collar system of claim 11 wherein the server is configured to operate the ML model to classify the at least one activity of the animal for each of the plurality of windows.

14. The animal collar system of claim 11 wherein the pre-process operation comprises classifying the data about the animal based upon at least one of an animal type, an animal breed, and an animal age.

15. The animal collar system of claim 11 wherein the mobile device is configured to generate video data of the animal, the video data of the animal being concurrent with the data about the animal; and wherein the server is configured to plot the data about the animal on a waveform, and segment the waveform based upon the video data of the animal.

16. The animal collar system of claim 11 wherein the plurality of sensing components comprises an inertial measurement unit (IMU) configured to generate motion data; and wherein the server is configured to filter the motion data.

17. The animal collar system of claim 11 wherein the at least one activity of the animal comprises a plurality thereof, the plurality of activities comprising barking, sleeping, walking, and running.

18. A method for monitoring an animal with an animal collar system comprising a mobile device associated with a user, a server coupled communicating with the mobile device over a network, and an animal collar device associated with the animal, the method comprising:
operating a local wireless transceiver in the animal collar device to communicate with the mobile device;
operating a plurality of sensing components animal collar device to collect data about the animal;
operating a processor in the animal collar device to transmit the data about the animal to the mobile device, the mobile device configured transmit the data about the animal to the server over the network; and
operating the server to classify at least one activity of the animal based upon the data about the animal and a machine learning (ML) model.

19. The method of claim 18 further comprising operating the server to perform a pre-process operation on the data about the animal, the pre-process operation comprising processing the data about the animal in a plurality of windows for the data about the animal.

20. The method of claim 19 wherein the pre-process operation comprises generating a plurality of variables for each of the plurality of windows, the plurality of variables comprising a mean value, a number of zero crosses, a statistical variance, an energy value, a peak-to-peak value, a minimum value, and a maximum value; and further comprising operating the server to ingest the plurality of variables for each of the plurality of the windows into the ML model, and operating the server to execute the ML model to classify the at least one activity of the animal for each of the plurality of windows.
